(19) United States
(12) Patent Application Publication
(10) Pub. No.: US 2026/0311710 A1
(43) Pub. Date: Oct. 8, 2026

(54) Source-Aware Unified Neural Audio Codec

(71) Applicant: Mitsubishi Electric Research Laboratories, Inc., Cambridge, MA (US)

(72) Inventors: Ryo Aihara, Cambridge, MA (US); Yoshiki Masuyama, Somerville, MA (US); Gordon Wichern, Boston, MA (US); François G. Germain, Quincy, MA (US); Jonathan Le Roux, Arlington, MA (US)

(73) Assignee: Mitsubishi Electric Research Laboratories, Inc., Cambridge, MA (US)

(21) Appl. No.: 19/456,642

(22) Filed: Jan. 22, 2026

Related U.S. Application Data
(63) Continuation-in-part of application No. 19/094,847, filed on Mar. 29, 2025.
(60) Provisional application No. 63/888,366, filed on Sep. 26, 2025.

(51) Int. Cl. G10L 19/008; G10L 19/038; G10L 25/30

(52) U.S. Cl. CPC G10L 19/008; G10L 19/038; G10L 25/30

(57) ABSTRACT

Embodiments disclosing systems and methods for source aware audio coding are provided. An audio coding system includes an input encoder that is configured to receive an input audio signal comprising a mixture of two or more sound sources. The encoder also generates a latent representation of the input audio signal. A conditional feature extractor is also provided that is configured to receive the latent representation and one or more prompts indicative of one or more of the sound sources in the mixture. Based on the prompts separated latent features corresponding to the one or more sound sources are generated. A quantizer discretizes the separated latent features into one or more sequences of codes. Further, a decoder is configured to reconstruct, from the one or more sequences of codes, one or more audio signals corresponding to one or more of the one or more sound sources indicated by the prompts.

### RELATED APPLICATION

This application is a continuation-in-part of U.S. patent application Ser. No. 19/094,847, filed Mar. 29, 2025, which is incorporated herein by reference in its entirety. U.S. patent application Ser. No. 19/094,847 describes systems and methods for prompt-conditioned source separation from audio mixtures. This application also claims the benefit of U.S. Provisional Patent Application No. 63/888,366, filed Sep. 26, 2025.

### TECHNICAL FIELD

The present disclosure relates generally to digital signal processing and audio compression. More particularly, some embodiments relate to systems and methods for source-aware neural audio coding, including encoding and reconstruction of sound sources within mixtures of sound sources.

### BACKGROUND

Audio compression systems are widely used for efficient storage and transmission of sound signals. Traditional codecs generally rely on signal processing techniques to convert audio waveforms into compact representations suitable for communication channels or digital media. More recently, neural audio codecs have been developed that employ machine learning techniques, such as convolutional encoders, residual vector quantizers, and decoders, to generate discrete token streams representing audio signals. Neural audio codecs can achieve high fidelity at low bitrates and are advantageous for integration with downstream machine learning systems.

In many real-world environments, audio signals often consist of mixtures of multiple sources, such as speech, music, and environmental sounds. Some approaches provide neural audio codecs that process such mixtures as single inputs, producing a compact but entangled representation of the whole mixture. While such approaches are suitable for certain use cases, they are less convenient for downstream tasks that focus on a particular source, such as speech recognition, music transcription, or event detection.

Various approaches have been proposed to address the presence of mixtures. For example, some source separation models are employed as a front-end prior to coding. For example, a task-aware source separation system can first separate a mixture into source-specific signals, which are then individually encoded using a neural audio codec. This approach provides disentangled representations but involves multiple processing stages.

Some other approaches provide domain-specific pathways within codecs. For instance, separate quantizers are provided for different categories of sounds, such as speech, music, and sound effects. These codecs can produce disentangled representations across categories, enabling more selective reconstructions. However, such architectures are typically designed for a predefined set of domains and may not readily extend to more complex or varied mixtures.

Accordingly, there remains a need for approaches that can provide enhanced processing for generating compact neural audio representations for diverse mixtures of sources in a flexible and efficient manner.

### SUMMARY

Some embodiments are based on a realization that neural audio codecs (NACs) provide compact representations that can be leveraged in many downstream applications, in particular large language models. Yet most NACs encode mixtures of multiple sources in an entangled manner, which may impede efficient downstream processing in applications that need access to only a subset of the sources (e.g., analysis of a particular type of sound, transcription of a given speaker, etc.). To that end, some embodiments provide a source-aware codec that encodes individual sources directly from mixtures, conditioned on source type prompts. This enables user-driven selection of which source(s) to encode, including separately encoding multiple sources of the same type (e.g., multiple speech signals).

Some approaches for generation of NACs in the speech and audio community employ a generative adversarial network (GAN) framework to learn a convolutional encoder for processing audio waveforms, a residual vector quantization (RVQ) module for discretization, and a deconvolutional decoder for waveform reconstruction. The RVQ outputs serve as discrete codec or tokens, enabling more efficient storage and transmission than continuous representations. However, these approaches suffer from a limitation that they implicitly produce an entangled representation of sound sources, which is not especially useful for applications that need to target single sources. While the token streams are increasingly used as inputs to downstream applications such as automatic speech recognition (ASR), music understanding, and audio event detection (AED), these tasks usually target a single source. Therefore, some embodiments are based on a realization that encoding and transmitting mixed audio without explicit source disentanglement is suboptimal and leads to unnecessary information loss.

Some approaches integrate multiple domain-specific RVQ modules into a convolutional NAC. While this design can disentangle multiple sources when the domains are predefined by the RVQs, however, it cannot separate multiple sources from the same domain, such as a mixture of two speech signals. Thus, some embodiments are based on a realization that a truly source-disentangled neural audio codec should be able to manage arbitrary combinations of source categories.

Some embodiments are based on recognition that a task-aware unified source separation (TUSS) model, followed by a NAC system is computationally inefficient because both TUSS and the NAC independently compute compact representations corresponding to the same audio sources, resulting in redundant computation.

To overcome the limitation of the cascaded architecture, some embodiments disclose a source-aware unified neural audio codec (SUNAC) model. The SUNAC model has learnable prompts, corresponding to speech, music, sound events (SFX), and so on, and estimates separated code sequences and signals sources specified by the prompts. The SUNAC model accepts a variable number of prompts and outputs simultaneously the corresponding number of separated code sequences and reconstructed source signals. This allows the SUNAC model to use the information from other prompts to improve the separation of a given prompt, and to output the desired number of sources in a single run of the SUNAC model. The SUNAC model is also configured to manage new combinations of sources at inference time, which were not seen during training.

Some embodiments provide the SUNAC model in the form of a SUNAC system that integrates source separation and coding into a single architecture. In one embodiment, an input encoder receives an input audio signal comprising a mixture of sources and generates a latent representation. A conditional feature extractor receives the latent representation and one or more prompts indicative of sources to be encoded and produces separated latent features conditioned on the prompts. A quantizer discretizes the separated latent features into code sequences, and a decoder reconstructs audio signals corresponding to the prompts.

In some embodiments, permutation-invariant training is applied to enable reconstruction of multiple sources of the same type, such as multiple concurrent speech signals. In further embodiments, the quantizer and decoder are shared across all source types, thereby avoiding the use of domain-specific quantizers. In certain embodiments, the system can operate in multiple modes, including encoding of a single source, encoding of selected sources from a mixture, encoding of multiple sources of the same or different types, or encoding of a mixture prompt representing a combined signal.

According to some embodiments, an audio coding system is provided. The audio coding system includes an input encoder that is configured to receive an input audio signal comprising a mixture of one or more sound sources and to generate a latent representation of the input audio signal. The audio coding system also includes a conditional feature extractor configured to receive the latent representation and one or more prompts indicative of one or more of the sound sources in the mixture. The conditional feature extractor is also configured to generate, based on the one or more prompts, separated latent features corresponding to the one or more sound sources corresponding to at least some of the one or more prompts. The audio coding system includes a quantizer configured to discretize the separated latent features into one or more sequences of codes. The audio coding system also includes a decoder configured to reconstruct, from the one or more sequences of codes, one or more audio signals corresponding to the one or more sound sources indicated by at least some of the one or more prompts.

According to other embodiments, a method for audio coding is provided. The method uses a processor coupled with stored instructions implementing the method, wherein the instructions, when executed by the processor conduct steps of the method, including receiving an input audio signal comprising a mixture of one or more sound sources. The steps of the method also include generating a latent representation of the received input audio signal. Further, the steps of the method include receiving one or more prompts indicative of one or more of the sound sources in the mixture. The steps of the method include generating, based on the latent representation and the received one or more prompts, separated latent features corresponding to the one or more sound sources corresponding to at least some of the one or more prompts. The steps of the method include separating via a quantizer the separated latent features into one or more sequences of codes. The steps of the method further include reconstructing, via a decoder, one or more audio signals from the one or more sequences of codes, corresponding to the one or more sound sources indicated by the at least some of the one or more prompts.

The described embodiments can provide beneficial technical effects, including reduced computational cost compared to cascaded separation and coding systems, improved flexibility in handling arbitrary or unseen mixtures, and enhanced downstream utility through disentangled and interpretable token streams. Additional advantages can include scalability, generalization to new prompt combinations, and consolidation of multiple functionalities into a single codec architecture.

Further features and advantages will become more readily apparent from the following detailed description when taken in conjunction with the accompanying drawings.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1 illustrates a block diagram showing an evolution of a source aware neural audio coding (NAC) system, according to an embodiment of the present disclosure.

FIG. 2 illustrates a detailed block diagram of the audio coding system, according to an embodiment of the present disclosure.

FIG. 3 illustrates a flowchart of a method for performing audio coding, according to an embodiment of the present disclosure.

FIG. 4A illustrates a schematic diagram showing an example implementation of the audio coding system, according to an embodiment of the present disclosure.

FIG. 4B illustrates a schematic diagram showing another example of operation of the audio coding system, according to an embodiment of the present disclosure.

FIG. 4C illustrates a schematic diagram showing another example of operation of the audio coding system, according to an embodiment of the present disclosure.

FIG. 4D illustrates a schematic diagram showing another example of operation of the audio coding system, according to an embodiment of the present disclosure.

FIG. 4E illustrates a schematic diagram showing another example of operation of the audio coding system, according to an embodiment of the present disclosure.

FIG. 5A illustrates an example block diagram of the conditional feature extractor, according to an embodiment of the present disclosure.

FIG. 5B illustrates a block diagram showing an example implementation of the conditional feature extractor, according to an embodiment of the present disclosure.

FIG. 6 illustrates a block diagram of the quantizer, according to an embodiment of the present disclosure.

FIG. 7A illustrates a block diagram showing working of the decoder, according to an embodiment of the present disclosure.

FIG. 7B illustrates a block diagram showing working of the decoder, according to an embodiment of the present disclosure.

FIG. 7C illustrates a block diagram showing working of the decoder, according to an embodiment of the present disclosure.

FIG. 8 illustrates a schematic diagram showing an example implementation of the audio coding system and its various modules and components, according to an embodiment of the present disclosure.

FIG. 9A and FIG. 9B collectively illustrate training of the audio coding system according to an embodiment of the present disclosure.

FIG. 10 illustrates a block diagram of the audio coding system showing an example use case of operation with combinations of prompts never seen during training, according to an embodiment of the present disclosure.

FIG. 11 illustrates a schematic diagram of an example user interface of the audio coding system, according to an embodiment of the present disclosure.

FIG. 12 illustrates a block diagram of the audio coding system configured to automatically identify sound sources in an audio mixture and to generate corresponding source-aware neural audio codes without requiring a user to manually specify the number or type of sources, according to an embodiment of the present disclosure.

FIG. 13A illustrates a block diagram showing an example use case of implementation of the audio coding system, according to an embodiment of the present disclosure.

FIG. 13B illustrates a block diagram of an example application of the audio coding system, according to an embodiment of the present disclosure.

FIG. 14 is a block diagram of a computing system that is used to implement the audio coding system for performing source aware neural audio code generation, according to embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art that fall within the scope and spirit of the principles of the presently disclosed embodiments.

### DETAILED DESCRIPTION

The following description provides exemplary embodiments only and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as outlined in the appended claims.

Specific details are given in the following description to provide a thorough understanding of the embodiments. However, understood by one of the ordinary skills in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail to avoid obscuring the embodiments. Further, reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware, or microcode, the program code or code segments to perform the necessary tasks may be stored in a machine-readable medium. A processor(s) may perform the necessary tasks.

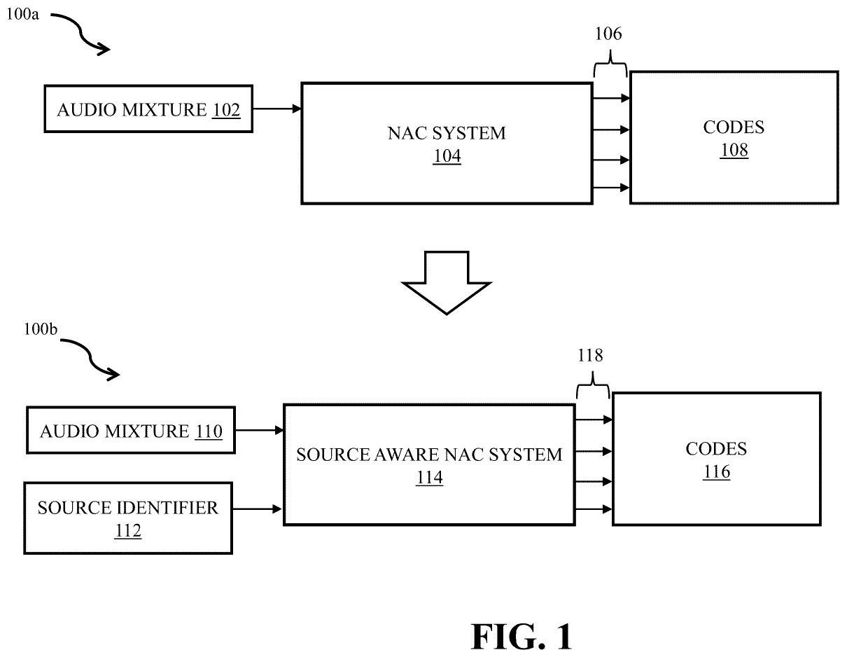

FIG. 1 illustrates a block diagram showing an evolution of a source aware neural audio coding (NAC) system, according to an embodiment of the present disclosure. The FIG. 1 illustrates an example comparison between an NAC processing pipeline 100a without source awareness, and an improved, source-aware NAC processing pipeline 100b.

The NAC pipeline 100a includes a NAC system 104 that receives an audio mixture 102, which may contain multiple sound sources. The NAC system 104 processes the audio mixture 102 and generates encoded representations 106, which are output through an interface in the form of codes 108. The codes 108 may then be used for further coding or decoding operations. The NAC pipeline 100a does not have awareness of the identities or characteristics of the underlying sources present in the audio mixture 102. Thus, the NAC pipeline 100a encodes the audio mixture 102 of multiple sources in an entangled manner, which may impede efficient downstream processing in applications that need access to only a subset of the sources (e.g., analysis of a particular type of sound, transcription of a given speaker, etc.).

Therefore, the NAC pipeline 100a is only able to encode the audio mixture 102 into a single, undifferentiated representation. While such representations may be compact and efficient for compression, they can be disadvantageous for tasks that typically require focus on a single source of interest. For example, in a multi-speaker conversation, an application such as automatic speech recognition may only need the tokens corresponding to one speaker, yet existing codes 108 provide only a combined representation. This recognition highlights an area where improved flexibility may be beneficial.

Some embodiments of the improved, source-aware NAC processing pipeline 100b are based on recognizing that an approach for addressing mixtures—namely, cascading a source separation model with a neural audio codec—may be computationally inefficient. In these cascaded systems, both the separation model and the codec compute compressed latent features independently, leading to redundant computation. Such redundancy can increase processing cost and limit deployment in resource-constrained scenarios. Accordingly, embodiments may seek to reduce or eliminate these inefficiencies by combining separation and coding into a unified process.

Other embodiments are based on recognizing that some approaches for source-disentangling codecs, such as those employing domain-specific quantizers for speech, music, and sound effects, can achieve separation across broad categories but cannot address mixtures involving multiple sources of the same type. For example, two concurrent speech signals may be mapped into the same quantizer pathway, preventing individual reconstruction. This recognition suggests that improved approaches can provide support for separating multiple same-category sources.

From these recognitions, some embodiments are based on the broader insight that audio codecs may beneficially incorporate source awareness directly into their design. Rather than operating blindly on mixtures, or relying on external separation modules, a codec can be conditioned by prompts or control inputs that identify which sources are to be encoded. Such conditioning can advantageously enable the codec to generate disentangled codes for one or more selected sources or for the mixture as a whole, thereby improving flexibility in use.

To that end, the source-aware NAC processing pipeline 100b disclosed in various embodiments described herein provides a source-aware codec that encodes individual sources directly from mixtures, conditioned on prompts such as source type prompts or natural language descriptions of the sources to be encoded. This enables user-driven selection of which source(s) to encode, including separately encoding multiple sources of the same type (e.g., multiple speech signals, multiple natural sounds, and the like).

The source-aware NAC processing pipeline 100b includes a source aware NAC system 114 that receives the audio mixture 110 which may be a mixture or a combination of one or more sound sources, such as speech, music, sound effects (SFX), and the like. The source aware NAC system 114 also receives a source identifier 112 information, which indicates which sound source or sound sources need to be processed for further applications, such as for computing codes corresponding to the sound source(s), from the audio mixture 110. In some embodiments, the source identifier 112 information also includes information that is used to provide a context to improve the quality of the encoding for those sources that need to be further processed, or are the sources that a user is interested in. The source identifier 112 may be in the form of prompts in some embodiments described herein. Additionally, the source identifier 112 supplies metadata or conditioning information describing one or more sources of interest in the mixture and optionally context sources.

Both the audio mixture 110 and the source identifier 112 are provided to the source-aware NAC system 114, which uses this additional information to generate source-informed encoded representations 118. These source-informed encoded representations 118 are output through an interface and delivered as codes 116 for further processing. This approach improves encoding performance by enabling the source aware NAC system 114 to adapt its processing based on the known or detected characteristics of specific sources in the audio mixture 110.

Based on the knowledge about the source(s) to separate, the source aware NAC system 114 employs an architecture that inherently uses the source awareness while processing the audio mixture and provides as output, the codes 116 from the encoded representations 118 of the different sound sources separated by the source aware NAC system 114 based on input knowledge of the sources to separate, as provided by the source identifier 112.

The internal architecture of the source aware NAC system 114 enables conditioning of the codes 116 by prompts or control inputs in the form of the source identifier that identifies which sources are to be encoded. Such conditioning can advantageously enable the source aware NAC system to generate disentangled codes 116 for one or more selected sources or for the audio mixture 110 as a whole, thereby improving flexibility in use. Thus, the source aware NAC system 114 is able to overcome the challenges described above for the NAC system 104, such as computational inefficiency, performance limitations while separating same type of sources of same category, and the like, to provide improved audio processing for downstream audio applications and tasks.

In some embodiments, the source-aware NAC system 114 is trained end-to-end with joint optimization.

In some embodiments, the source-aware NAC system 114 performs prompt-based source feature extraction directly in the latent space, after which a quantizer estimates codes on the separated features. To address permutation ambiguity when processing multiple sources of the same type, some embodiments disclose permutation invariant training (PIT) in the feature space.

The internal architecture of the source aware NAC system 114 is described in various embodiments and accompanying figures provided herein.

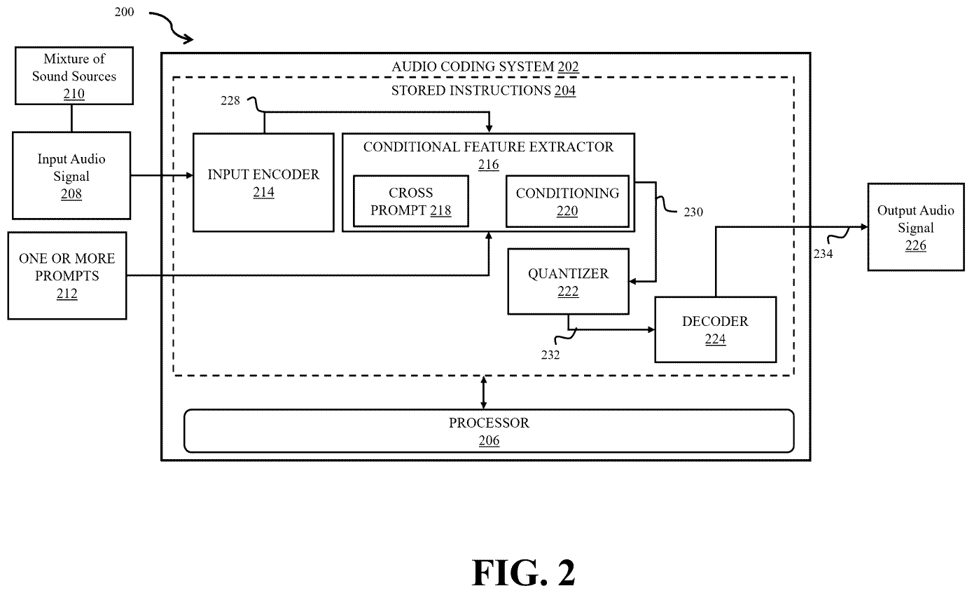

FIG. 2 illustrates a block diagram 200 of an architecture of the source aware NAC system 114 implemented as an audio coding system 202, according to an embodiment of the present disclosure. FIG. 2 is an example implementation of the source aware NAC pipeline 100b illustrated in FIG. 1. The source aware NAC system 114 may be implemented as the audio coding system 202 including a processor 206 coupled with stored instructions 204.

The processor 206, as used herein, refers to any processing unit capable of executing instructions stored in memory to perform operations associated with the audio coding system 202 of the present disclosure. The processor 206 may include a single-core or multi-core CPU, microcontroller, DSP, ASIC, FPGA, or SoC. The processor 206 may execute software or firmware instructions stored in volatile or non-volatile memory to perform data processing, control logic execution, or communication handling. The processor 206 may also incorporate specialized components such as GPUs, AI accelerators, or encryption modules to enhance performance and security. The processor 206 may communicate with peripheral devices, sensors, or networks via wired or wireless interfaces and operate under an operating system or real-time environment in some embodiments. The processor 206 with its different capabilities causes execution of different modules which include at least—an input encoder 214, a conditional feature extractor 216 including a cross prompt module 218 and a conditioning module 220, a quantizer 222, and a decoder 224. The different modules are blocks of data stored in the form of the stored instructions 204. The stored instructions 204 are executed by the processor 206, which causes the modules of the stored instructions 204 to perform operations that enable the audio coding system 202 to perform its functionality.

The stored instructions 204 may include one or more sequences of computer-executable operations that, when executed by one or more processors, such as the processor 206, cause the one or more processors to perform the functions or processes described herein for the audio coding system 202. These stored instructions 204 may reside within a “memory,” may include a tangible, non-transitory computer-readable medium configured to hold the stored instructions 204 as well as associated data. The memory may include volatile elements (e.g., RAM, cache) and non-volatile elements (e.g., ROM, flash memory, magnetic storage, or optical storage). The stored instructions 204 may be organized as modules, routines, or code segments and may be implemented in any suitable programming language or firmware format, such as in the form of the modules listed above and shown in FIG. 2. The memory may additionally store configuration parameters, model weights, intermediate processing outputs, or other information utilized during operation of the audio coding system 202 described herein, as performed by the different modules shown in FIG. 2. The different modules include, for example, the input encoder 214.

The input encoder 214 is configured to receive an input audio signal 208 comprising a mixture of one or more sound sources 210 and to generate a latent representation 228 of the input audio signal 208. To that end, the input audio signal 208 may include an audio signal provided to the input encoder 214 system for processing. The input audio signal 208 may be generated by a microphone that receives the mixture of one or more sound sources 210 from the environment. The microphone receives the audio mixture 210 and transduces acoustic pressure variations produced by multiple sound sources in the audio mixture 210 into a corresponding electrical signal, wherein the electrical signal represents a superposition of the sound waves present at the microphone. The audio signal may be any signal representing sound, including but not limited to speech, music, sound effects, environmental noise, musical instruments, natural sounds, machine sounds, or mixtures thereof, whether captured from a microphone, generated synthetically, or obtained from a stored file. The input audio signal 208 may include a single source, multiple sources, or the mixture of sound sources 210 like speech, music, sound effects, and the like.

Each sound source in the mixture of sound sources 210 may include a constituent component of an audio signal, including but not limited to a speaker, a musical instrument, a sound effect, or other acoustic event. Thus, the overall mixture of sound sources 210 is an audio signal that contains one or more sound sources overlapping in time or frequency. The sound sources may be of the same type (e.g., multiple speakers) or of different types (e.g., speech and background music).

As the input encoder 214 receives the input audio signal 208 including the mixture of one or more sound sources 210, the input audio signal 208 is processed further. To that end, the input encoder 214 includes one or more hardware or software components configured to transform the input audio signal 208 into the latent representation 228. The input encoder 214 may include convolutional layers, recurrent layers, transformer layers, or any other feature extraction modules. The input encoder 214 may generate time-domain or time-frequency domain features for the input audio signal 208 to transform the input audio signal 208 into the latent representations 228. The latent representation 228 forms a compressed or transformed representation of the input audio signal 208, expressed in a continuous or discrete domain, suitable for further processing by other modules of the audio coding system 202. The latent representation 228 is passed to the conditional feature extractor 216 for further processing.

The conditional feature extractor 216 is configured to receive the latent representation 228 and one or more prompts 212 indicative of one or more of the one or more sound sources in the mixture of sound sources 210, and to generate, based on the one or more prompts 212, one or more one or more separated latent features 230 corresponding to the one or more of the one or more sound sources in the mixture of sound sources 210 received as the input audio signal 208 by the input encoder 214.

In some embodiments, the one or more prompts 212 include one or more target prompts, as at least some of the one or more prompts that are indicative of one or more target sound sources, that is the one or more of one or more sound sources among the one or more sound sources, and to generate, based on these at least some of the one or more prompts 212, one or more separated latent features corresponding to the one or more target sound sources corresponding to the one or more target prompts. To that end, the rest of the prompts in the one or more prompts 212, besides the target prompts, may be context prompts that are provided as input only to give a context to the input encoder 214 for encoding, and to the cross prompt module 218 for jointly processing the latent representation 228 and the one or more prompts 212 to generate transformed prompts and transformed features.

In some embodiments, each of the one or more prompts 212 may include a control signal or input indicative of a source type, source identity, or mixture to be extracted, encoded, or reconstructed. The one or more prompts 212 may include symbolic tokens (e.g., <Speech>, <Music>, <SFX>), natural language descriptions (e.g., “the speech of a male speaker”, “the speech of a French-speaking female speaker”, “the sound of a distorted electric guitar”, “the sound of car engine revving”, and the like), learned embedding vectors, or combinations thereof. The one or more prompts 212 may also be obtained automatically from an audio tagging, audio captioning, or source-counting system.

The one or more prompts 212 may include tokens indicative of source categories such as speech, music, sound effects, environmental sounds, acoustic events, or mixtures. For instance, a prompt <Speech> may guide the system to output a representation of speech components within a mixture, while <Music> may guide extraction of musical content, which may be related to music sources like drums, guitars, bass, vocals, full music track, and the like. A prompt <SFX> may indicate a sound effect such as footsteps, UI clicks, vehicle sounds, door opens/closes, and the like. A prompt for an environmental or ambience sound may indicate such as rain, thunder, birds chirping, crowd murmur, and the like. The one or more prompts 212 may also indicate any acoustic event such as any identifiable or meaningful sound occurrence in the input audio signal 208. The acoustic event may be defined by a bounded segment of sound that corresponds to a specific action, source, or phenomenon.

Mixture prompts such as <Mix> may instruct the audio coding system 202 to generate a compact representation of the entire input mixture of sound sources 210. This mechanism provides selective control over the encoded outputs, enabling flexible downstream usage. In some embodiments, one or more of the one or more prompts 212 indicate a context for encoding of the sound sources that a user is actually interested in processing. This may improve the overall encoding performed by the input encoder 214 and the subsequent modules of the audio coding system 202.

In some embodiments, the one or more of the one or more prompts 212 that indicate the context for encoding rather than explicit source-selection prompts, which is the context prompts, provide auxiliary information regarding the sound environment, background content, or non-target sound categories present in the input mixture of sound sources 210. For example, a context prompt may indicate the presence of background music, ambient sound effects, or environmental noise, while the user is primarily interested in coding a speech source.

In some embodiments, the audio coding system 202 uses the context prompts to condition internal feature representations and separation behavior, such as by suppressing, grouping, or deprioritizing non-target sources during latent feature extraction. However, the audio coding system 202 does not necessarily generate separate neural audio code sequences for the non-target sources identified by the context prompts. Instead, the context prompts influence how the target sound sources are encoded, thereby improving coding efficiency, reconstruction quality, or robustness without increasing the number of output code streams.

This prompt-based contextual conditioning enables flexible and efficient source-aware neural audio coding by allowing users or upstream systems to specify what is important in the mixture without requiring explicit enumeration or separation of every sound source present.

The conditional feature extractor 216 may include a cross-prompt module 218 that is configured to jointly process the latent representation 228 and the at least some of the one or more prompts 212 to generate transformed prompts and transformed features. The transformed prompts and the transformed features are then passed to a conditional module 220 of the conditional feature extractor 216. The conditional module 220 is then configured to perform feature-wise modulation of the transformed features using the transformed prompts, to generate the one or more one or more separated latent features 230 corresponding to the one or more of the one or more sound sources in the mixture of sound sources 210. The conditional module 220 may only perform feature-wise modulation of the transformed features using the transformed prompts corresponding to the target prompts, and not for the context prompts, to save computational resources, in some embodiments.

In some embodiments, the overall combination of the input encoder 214 and the conditional feature extractor 216 forms an enhanced encoding architecture to provide a source aware NAC pipeline, such as the NAC pipeline 100b illustrated in FIG. 1.

The one or more one or more separated latent features 230 are then passed to a quantizer 222 that is configured to discretize the one or more separated latent features 230 into one or more sequences of codes 232. Further, the one or more sequences of codes 232 are then passed to a decoder 224 that is configured to reconstruct, from the one or more sequences of codes 232, one or more output audio signals 226 corresponding to the one or more of the one or more sound sources indicated by the one or more prompts 212. The decoder 224 may only reconstruct the one or more sequences of codes 232 corresponding to the target prompts, and not for the context prompts, to save computational resources, in some embodiments.

In this manner, the audio coding system 202 is configured to perform a source aware audio coding of the different sources in the mixture of sound sources 210, thereby enabling a more generalized, easily scalable, flexible, and efficient audio coding approach that may be used in a wide range of downstream applications such as automatic speech recognition, AR/VR, captioning, transcription applications, and the like.

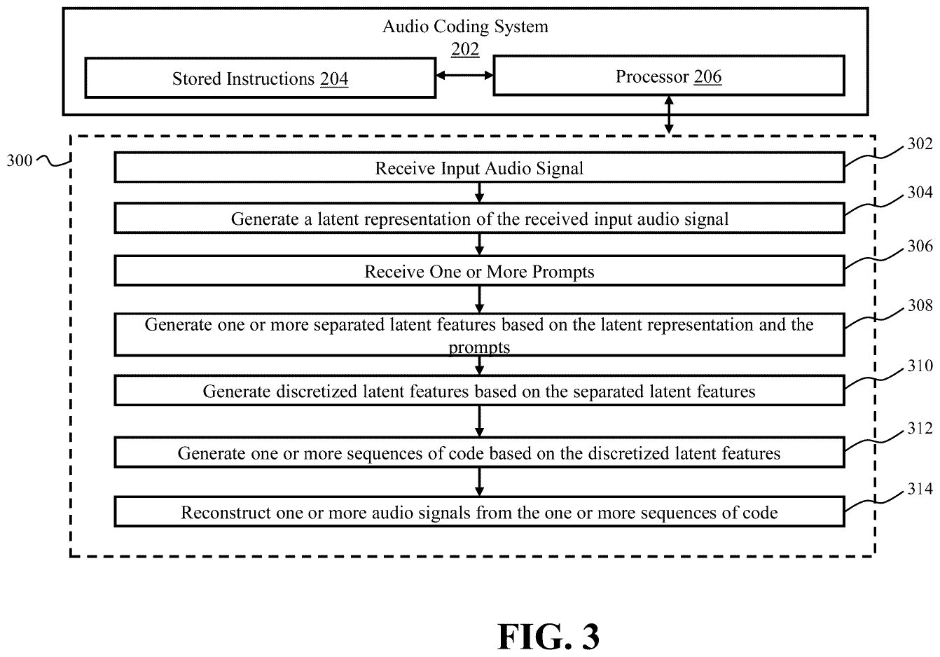

The functionality of various modules of the audio coding system 202 will be described in greater detail in the following description. The functionality of the audio coding system 202 as elaborated using various modules shown in FIG. 2 may be implemented by a method, such in the form of a computer algorithm, code, or program instructions, executed by the processor 206. An example of such a method is shown in FIG. 3.

FIG. 3 illustrates a flowchart of a method 300 for performing audio coding by the audio coding system 202, according to an embodiment of the present disclosure. FIG. 3 is explained in conjunction with elements from FIG. 2. The method 300 may be executed by the audio coding system 202. To that end, the audio coding system 202 includes stored instructions 204 maintained in a non-transitory memory and executed by the processor 206 coupled to the memory. The processor 206, when executing the stored instructions, performs the computer-implemented steps of the method 300 shown in FIG. 3. The steps of the method 300 include, for example, at step 302, the receiving an input audio signal comprising a mixture of two or more sound sources through one or more hardware audio interfaces. For example, the audio coding system 202 may be a computing device including a microphone and audio sensors that capture the input audio signal 208 corresponding to the mixture of sound sources 210.

The method 300 further include at step 304, generating a latent representation of the received input audio signal corresponding to the mixture using one or more learned transform models, neural encoders, or other signal-processing components implemented by the audio coding system 202. For example, the audio coding system 202 includes the input encoder 214 that receives the input audio signal 208 and generates the latent representation 228 corresponding to the input audio signal 208.

The method 300 further includes, at step 306, receiving one or more prompts indicative of one or more of the sound sources present in the mixture. For example, the one or more prompts 212 indicative of the one or more sources present in the mixture of sound sources 210, that a user may be interested in encoding or focusing on for generating a code sequence are received at an input interface of the audio coding system 202, and passed to the conditional feature extractor 216. As explained in conjunction with FIG. 2, these prompts may include machine-interpretable conditioning vectors, semantic tags, numerical identifiers, or other electronic inputs that influence source-specific processing by the audio coding system 202.

The method 300 further includes, at step 308, generating one or more separated latent features corresponding to one or more of the one or more sound sources based on the latent representation and the received prompts. This separation is performed automatically by executable trained machine learning models in some embodiments. For example, the conditional feature extractor 216 including the cross prompt module 218 and the conditioning module 220 is configured to generate the one or more separated latent features 230 based on the latent representation 238 generated by the encoder, and the received one or more prompts 212.

Further, the method 300 includes, at step 310, generating discretized latent features via a quantizer. For example, the quantizer 222 receives the one or more separated latent features 230 and discretizes then to generate, at step 312, one or more sequences of codes 232. In an embodiment, the quantizer 222 may implement vector quantization, residual vector quantization, codebook assignment, or other machine-executed discretization operations that reduce the representation size of the one or more separated latent features 230. Thus, the one or more sequences of codes 232 correspond to a compressed representation of the separated latent feature 230, that are suitable for storage or transmission.

The method 300 also includes, at step 314, reconstructing, via a decoder, one or more audio signals corresponding to the one or more of the one or more sound sources indicated by the prompts, using one or more learned or algorithmic decoding models. For example, the decoder 224 is configured to reconstruct audio signals 234 corresponding to the one or more sequences of codes 232. The reconstructed audio signals may be output such as in the form of output audio signal 226, stored, provided to downstream components, or rendered on an output interface.

The cooperation of the processor 206, the stored instructions 204, the input encoder 214, the conditional feature extractor 216, the quantizer, and the decoder 224 forms a specialized machine that performs audio coding and reconstruction in a manner described by the various steps of the method 300. As a result, the audio coding system 202 performs the source aware audio coding, suitable for use in many applications. The audio coding system 202 and the method 300 may be implemented in various combinations of embodiments, as described in the following description.

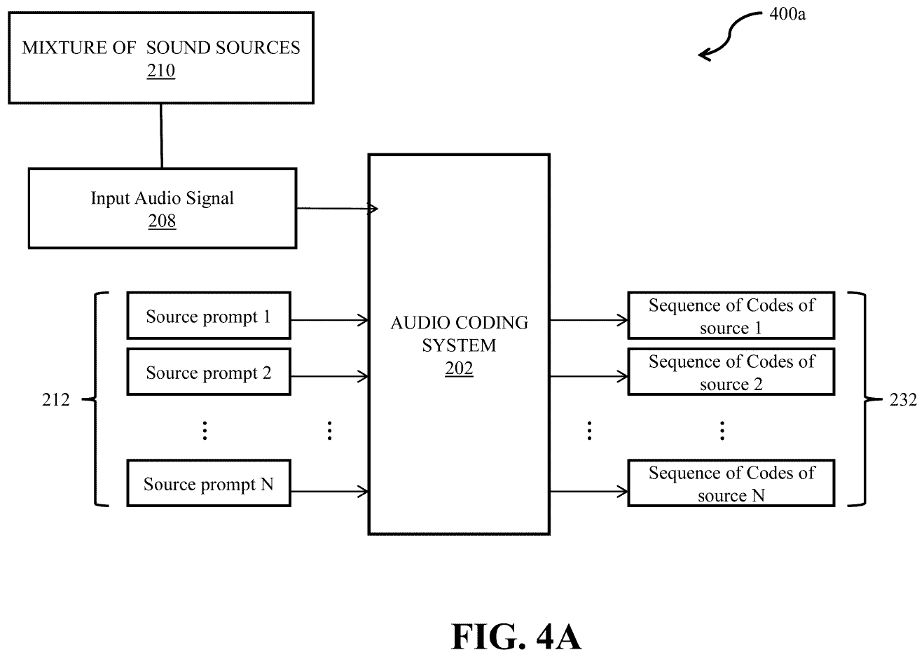

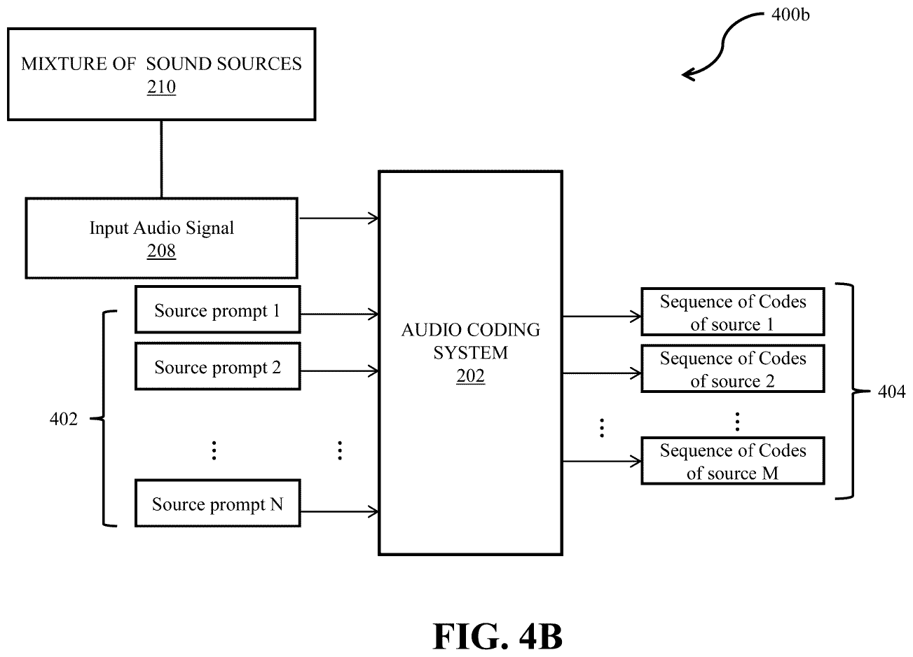

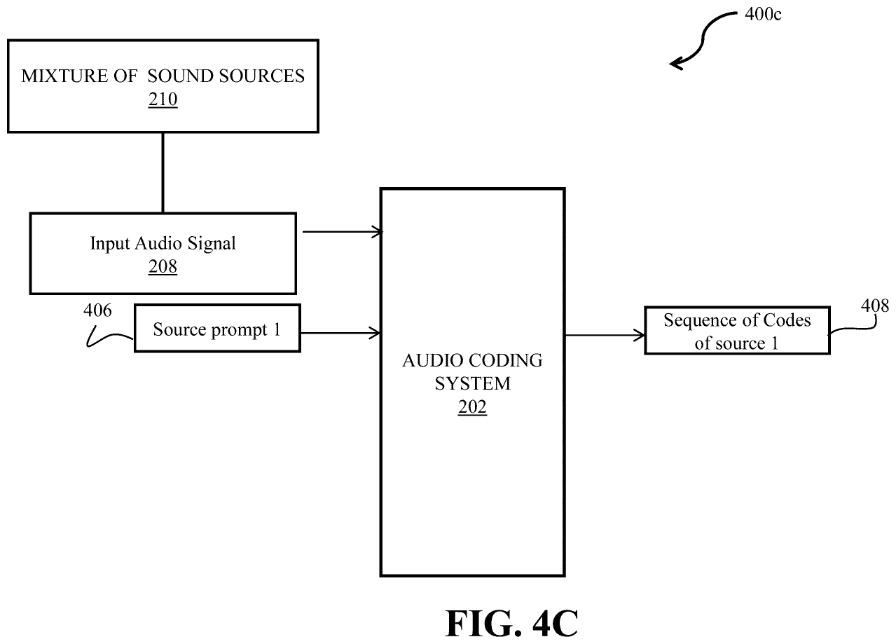

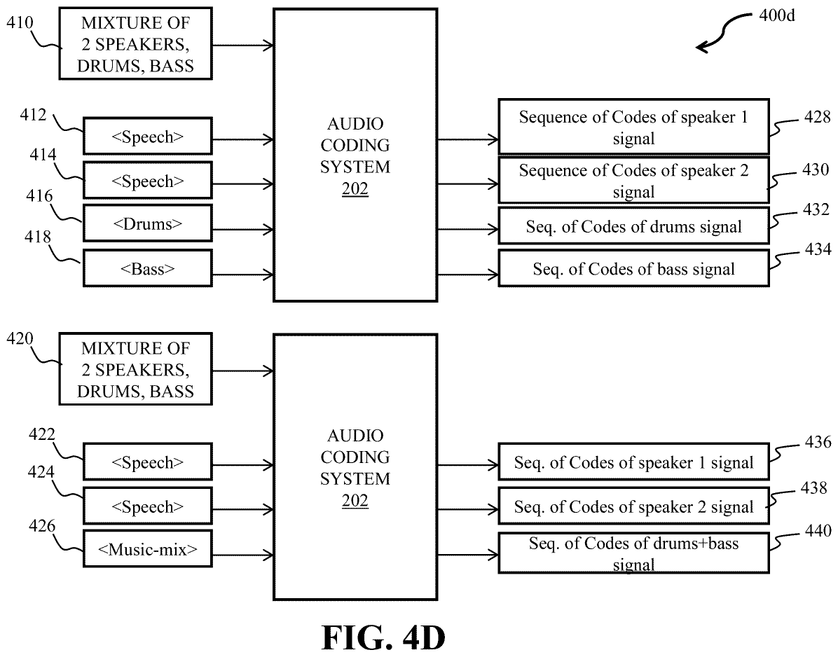

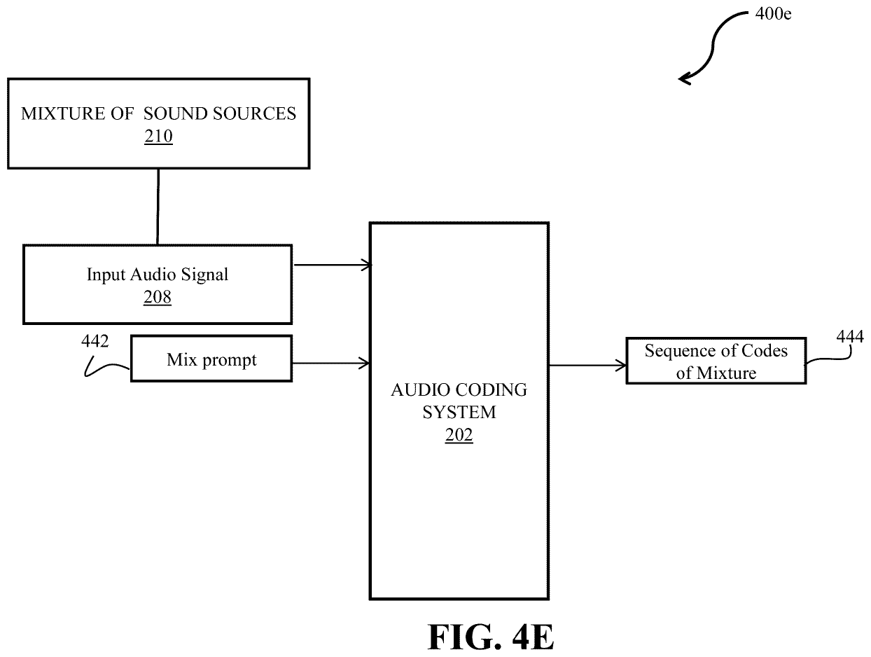

FIG. 4A illustrates a schematic diagram 400a showing an example implementation of the audio coding system, according to an embodiment of the present disclosure. FIG. 4A is explained in conjunction with elements from FIG. 2 and FIG. 3.

As shown in FIG. 4A, the audio coding system 200 may take an input, the input audio signal 208 corresponding to the mixture of sound sources 210 and the one or more prompts 212. In an embodiment as shown in FIG. 4A, the one or more prompts 212 are indicative of one or more sources or groups of sources present in the mixture of sound sources 210. For example, a source prompt 1 in the one or more prompts 212 may indicate a source 1 in the mixture of sound sources 210, a source prompt 2 in the one or more prompts 212 may indicate a source 2 in the mixture of sound sources 210, a source prompt N in the one or more prompts 212 may indicate a source N in the mixture of sound sources 210, and the like. The audio coding system 202 processes each of the prompts in the one or more prompts 212 to generate source aware sequences of codes 232 output as many separated codes as input prompts, wherein each separated sequence of codes in the sequences of codes 232 corresponds to each input prompt in the one or more prompts 212. For example, as shown in the schematic diagram 400a, a sequence of codes of source 1 corresponds to the source prompt 1, a sequence of codes of source 2 corresponds to the source prompt 2, a sequence of codes of source N corresponds to the source prompt N, and the like.

In various embodiments, the audio coding system 202 may be configured to operate in various modes. In some embodiments, the audio coding system 202 may operate in a first mode in which a single prompt produces a single code sequence.

In some embodiments, the audio coding system 202 may operate in a second mode, in which multiple prompts produce multiple code sequences corresponding to different sources. For example, the schematic diagram 400a shows the second mode of operation of the audio coding system 202. Another example of the second mode of operation of the audio coding system 202 is shown in FIG. 4B.

In some embodiments, the audio coding system may operate in a third mode in which a mixture prompt produces a code sequence representing a combination of sources.

FIG. 4B illustrates a schematic diagram 400b showing another example of operation of the audio coding system 202, according to an embodiment of the present disclosure. FIG. 4B may be an example of the second mode of operation of the audio coding system 202.

As shown in FIG. 4B, the audio coding system 202 may take as input the mixture of sound sources 210 and multiple input prompts 402 indicative of multiple sources or groups of sources present in the mixture of sound sources 210, and output one or more code sequences 404 corresponding to a subset of the multiple input prompts 402, wherein each code sequence corresponds to an input prompt. In some embodiments, the audio coding system 202 may be trained to use some of the multiple prompts to provide context for generation and the output of the one or more code sequences 404. For example, the number of prompts provided as input to the audio coding system 202 is N and the number of code sequences provided as output is M, and M<N in the example shown in FIG. 4B.

In some embodiments, the audio coding system 202 may take as input the mixture of sound sources 210 and multiple input prompts 402 indicative of multiple sources or groups of sources present in the mixture of sound sources 210, including one or more target prompts indicative of target sound sources or target groups of sound sources among the sound sources in the mixture of sound sources, and output one or more code sequences 404 corresponding to the one or more target prompts among the multiple input prompts 402, wherein each code sequence corresponds to one of the target prompts. In some embodiments, the audio coding system 202 may be trained to use some of the one or more prompts, which is the context prompts, to provide context for the generation and the output of the one or more code sequences 404. For example, the number of prompts provided as input to the audio coding system 202 is N and the number of target prompts and the number of code sequences provided as output are M, and M<N in the example shown in FIG. 4B.

FIG. 4C illustrates a schematic diagram 400c showing another example of operation of the audio coding system 202, according to an embodiment of the present disclosure. FIG. 4C may be an example of the first mode of operation of the audio coding system 202.

As shown in FIG. 4C, the audio coding system 202 takes as input a single source prompt 406 and produces as output a single corresponding separate code sequence 408.

FIG. 4D illustrates a schematic diagram 400d showing another example of operation of the audio coding system 202, according to an embodiment of the present disclosure.

FIG. 4D illustrates example input and output signal configurations that may be processed by the audio coding system 202 to generate source-specific coded representations of audio signals.

In an embodiment, the audio coding system 202 receives a mixture of audio signals 410 comprising a combination of two speakers, drums, and bass. In addition to the mixture of audio signals 410, the audio coding system 202 receives a plurality of prompts, such as a speech prompt 412 and a speech prompt 414 corresponding to two different speaker sources, a drums prompt 416 corresponding to a drums source, a bass prompt 418 corresponding to a bass source, such that each prompt is indicative of a respective sound source present in the mixture of audio signals 410. Each of the prompts may include machine-interpretable identifiers, feature vectors, or other conditioning data provided to the audio coding system through an electronic interface.

During operation, the processor 206 of the audio coding system 202, executing stored instructions 204 maintained in a non-transitory memory, generates source-conditioned latent representations 228 and corresponding discretized latent features for each of the indicated sound sources. The audio coding system 202 then encodes these discretized latent features to produce code sequences, such as code sequence of the speaker 1 signal 428, code sequence of the speaker 2 signal 430, code sequence of the drums signal 432, and code sequence of the bass signal 434, each representing a compressed machine-readable code sequence corresponding to a specific source extracted from the mixture of audio signals 410. These code sequences may be stored, transmitted, or supplied to the decoder 224 for later reconstruction of the individual audio signals.

In another embodiment, as shown in the lower portion of FIG. 4D a mixture signal 420 comprising two speakers, drums, and bass is input to the audio coding system 202. In this example, the one or more prompts 212 include a speech prompt 422 and a speech prompt 424 corresponding to two speech sources, while a prompt 426 corresponds to a combined music-mix source (e.g., drums and bass treated as a single source category). Based on the prompts and the mixture signal, the audio coding system 202, through processor-executed machine operations, generates code sequence of the speaker 1 signal 436, code sequence of the speaker 2 signal 438, and code sequence of the drums+bass signal 440. These code sequences represent compressed digital representations for each respective indicated source or grouped source.

The examples shown in FIG. 4D illustrate that the audio coding system 202 may receive mixture audio content along with one or more prompts identifying individual or grouped sound sources, and may output corresponding source-specific coded sequences generated by machine-executed separation, quantization, and encoding operations. The configurations demonstrate that the audio coding system 202 is capable of producing different sets of code sequences depending on the source prompts provided, thereby enabling selective and flexible audio coding driven by source-level control inputs.

FIG. 4E illustrates a schematic diagram 400e showing another example of operation of the audio coding system 202, according to an embodiment of the present disclosure. FIG. 4E may be an example of a first mode of operation of the audio coding system 202. As shown in FIG. 4E, the audio coding system 202 may receive as input a mix prompt 442 corresponding to the mixture of audio sources 210 and generate or produce as output a single corresponding code sequence 444 for the entire mixture of sound sources 210.

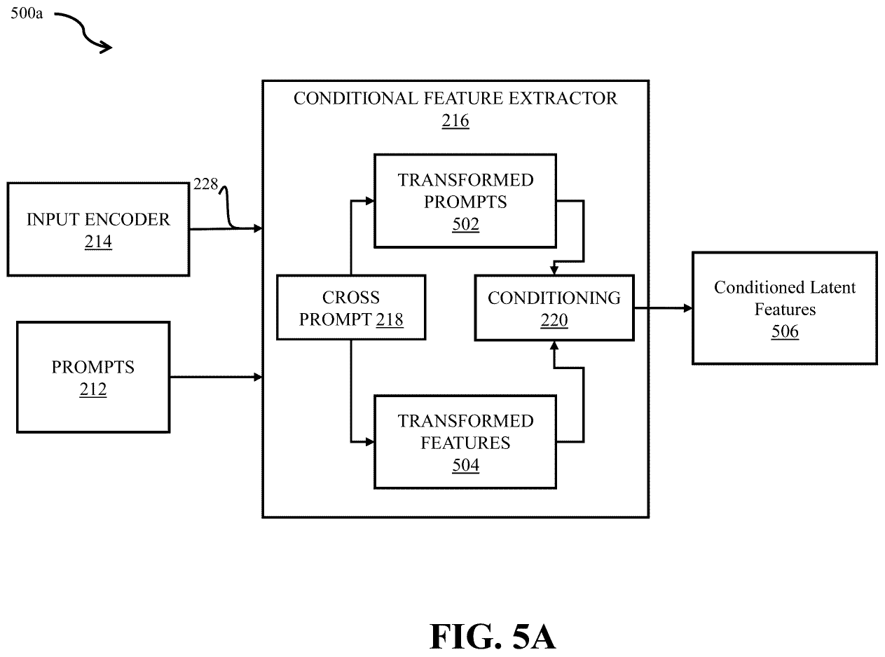

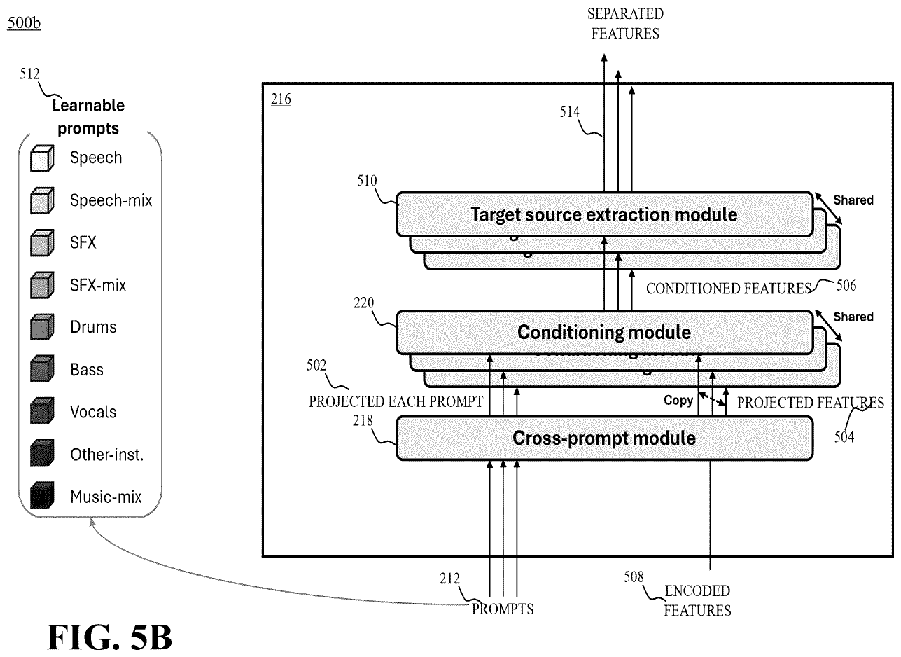

Thus, the audio coding system 202 is capable of changing its behavior, including the number of outputs, based on the type and number of one or more prompts 212, provided for the same input mixture. The operation of the audio coding system 202 is described through various components such as the conditional feature extractor 216 described next in FIG. 5A.

FIG. 5A illustrates an example block diagram 500a of the conditional feature extractor 216, according to an embodiment of the present disclosure. FIG. 5A is explained in conjunction with FIG. 2 and FIG. 3. The conditional feature extractor is a machine-implemented module executed by one or more processors, such as the processor 206, and configured to operate on digital representations of audio signals. As shown, the conditional feature extractor 216 receives the latent representation 228 generated by the input encoder 214 for the input audio signal 208 corresponding to the mixture of sound sources 210, and the one or more prompts 212 indicative of one or more of the one or more sound sources present in an input audio mixture of sound sources 210.

The conditional feature extractor 216 includes the cross-prompt module 216 and the conditioning module 218, each implemented using executable stored instructions 204 stored in a non-transitory computer-readable memory. The cross-prompt module 216 is configured to jointly process the latent representation 228 and the one or more prompts 212 to produce transformed prompts 502 and transformed features 504. In some embodiments, the cross-prompt module 216 implements transformer layers, multi-head attention layers, positional encoding structures, or other neural or signal-processing architectures enabling joint representation learning across prompts and between prompts and latent features.

The conditional feature extractor 216 further includes the conditioning module 220 configured to perform feature-wise modulation of the transformed features 504 using the transformed prompts 502. The conditioning module 220 may implement feature-wise linear modulation (FiLM), gating layers, attention-based modulation, or other machine-executed conditioning mechanisms that adapt the latent features 228 according to the prompt information provided by the one or more prompts 212. The output of the conditioning module 220 includes conditioned latent features 506 associated with one or more of the sound sources indicated by the one or more prompts 212.

In some embodiments, the conditional feature extractor 216 is trained to reconstruct both separated sources and mixtures of sources, depending on whether the conditional feature extractor 216 module receives (i) source-specific prompts identifying individual sound sources or (ii) mixture prompts identifying multiple grouped sound sources. This dual reconstruction capability enables the conditional feature extractor 216 to support flexible control scenarios for audio coding and separation.

The conditional feature extractor 216 may also be configured to disentangle multiple sound sources of a same type using permutation-invariant training procedures, allowing the audio coding system 202 to correctly separate, identify, and encode individual sources even when their ordering is ambiguous or interchangeable (e.g., two speech sources). In certain embodiments, the quantizer 222 and the decoder 224 downstream from the conditional feature extractor 216 are shared across the one or more sound sources, enabling a unified coding pipeline with reduced model size and consistent source representation.

An example of implementation of the conditional feature extractor 216 is shown in FIG. 5B.

FIG. 5B illustrates a block diagram 500b showing an example implementation of the conditional feature extractor 216, according to an embodiment of the present disclosure. FIG. 5B is explained in conjunction with elements from FIG. 2, FIG. 3, and FIG. 5A. In the embodiment shown in FIG. 5B, the conditional feature extractor 216 includes the cross-prompt module 218, the conditioning module 220, and a target source extraction module 510, each implemented as a machine-executed functional block operating on encoded audio features and prompt vectors.

The conditional feature extractor receives the one or more prompts 212, which may include one or more learnable prompts 512, examples of which are shown on the left side of FIG. 5B. Such learnable prompts may include, without limitation, prompts corresponding to speech, speech-mix, sound effects (SFX), SFX-mix, drums, bass, vocals, other instruments, and music-mix. The learnable prompts 512 may be stored as machine-learnable embedding vectors or trainable parameters that encode semantic information regarding corresponding sound sources or mixtures of sources.

To that end, the learnable prompts 512 are trainable parameter vectors that represent different sound-source categories (e.g., speech, SFX, drums, bass, vocals, music-mix) or mixture types (e.g., speech-mix, SFX-mix). Each learnable prompt is an embedding whose values may be optimized during training of the audio coding system 202 so that a model associated with the learnable prompts 512 learns how a particular prompt should influence the extraction of source-specific or mixture-specific features. The learnable prompts 512 encode semantic information associated with a particular sound source or mixture type. The learnable prompts 512 are updated during model training and is used to condition one or more neural modules to extract, separate, or transform features corresponding to the indicated sound source.

The conditional feature extractor 216 receives encoded features 508, which correspond to the latent representation 228 shown in FIG. 2, and as generated by an upstream encoder (e.g., input encoder 214). The encoded features 508 and the one or more prompts 212 are jointly processed by the cross-prompt module 218. In one embodiment, the cross-prompt module 218 is configured to perform joint representation learning between the encoded features 508 and prompt vectors corresponding to the one or more prompts 212, and also to enable information-sharing between all the prompts 212 and the encoded features 508. As a result of the joint processing the cross-prompt module 218 generates projected features which are the transformed features 504 and projected prompts which are the transformed prompts 502, as shown. The cross-prompt module 218 may include one or more neural network layers, transformer-based attention layers, positional encoding mechanisms, or other computational structures suitable for performing cross-modal or cross-conditioning interactions. In some embodiments, the projected prompts are replicated or copied across time steps or feature dimensions for conditioning downstream modules.

The transformed prompts 502 and the transformed features 504 are passed to the conditioning module 220 that may perform feature-wise modulation of the transformed features 504 using the transformed prompts 502. The conditioning module 220 may also perform gating operations, attention-based feature scaling, concatenation-based conditioning, or other feature adaptation operations. In some embodiments, the conditioning module 220 applies modulation parameters derived from the projected prompts to the projected features so that the transformed features 504 become conditioned on the semantic meaning or class associated with each of the transformed prompt 502.

In some embodiments, as shown in FIG. 5B, the conditioning module 220 is used as a shared module, illustrating that the same conditioning operations may be used for different prompt types or source categories. The output of the conditioning module 220 includes the conditioned features 506 that are provided to a target source extraction module 510, which further processes the conditioned features 506 to generate target conditioned features 514 associated with one or more target sound sources. The target conditioned features 514 correspond to the one or more separated latent features 230 disclosed in FIG. 2 that are produced as an output from the conditional feature extractor 216. In one embodiment, the target source extraction module 510 performs prompt-guided extraction, enhancement, suppression, or filtering operations that isolate features corresponding to the source(s) indicated by the received prompts 212. The target source extraction module 510 may also be implemented as a shared neural sub-network, reused across different prompt types or across different target sources. The resulting target-conditioned features 514 may then be supplied to downstream components such as a quantizer, decoder, or source-specific reconstruction module.

As shown in FIG. 5B, the three modules—the cross-prompt module 218, the conditioning module 220, and the target source extraction module 510—operate sequentially to transform raw encoded features 508 into target-conditioned features 514 that are conditioned on specific learnable prompts 512. This arrangement enables the audio coding system 202 to flexibly extract and encode a wide range of sound sources or mixtures of sources from an input audio mixture using prompt-based control signals. All operations shown in FIG. 5B are performed automatically by one or more processors, such as the processor 206 executing the stored instructions 204.

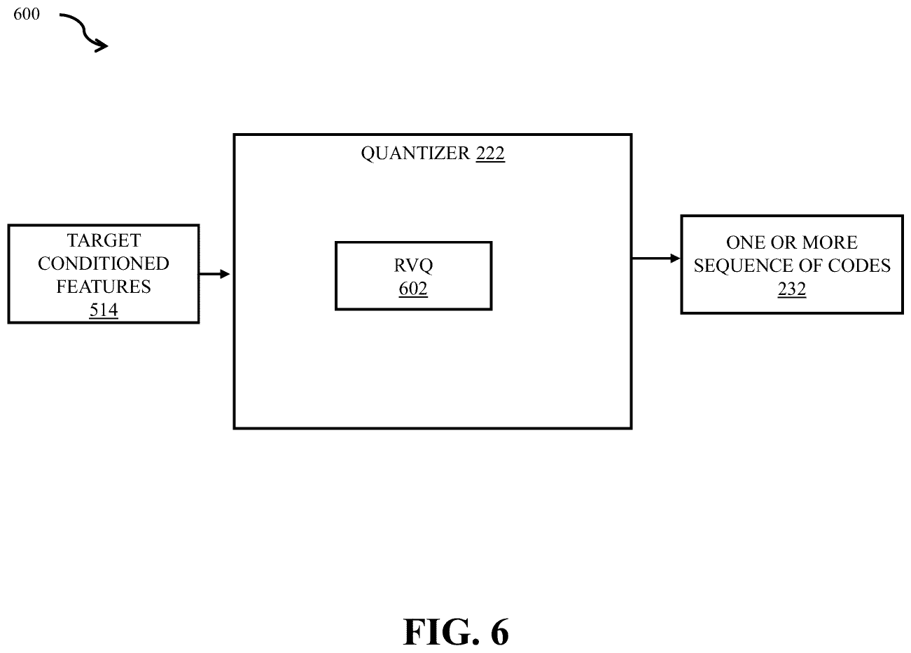

FIG. 5A and FIG. 5B jointly represent the architecture and working of the conditional feature extractor 216 according to some embodiments. The audio coding system 202 also includes the quantizer 222 whose operation is described in conjunction with FIG. 6 below.

FIG. 6 illustrates a block diagram 600 of the quantizer 222, according to an embodiment of the present disclosure. FIG. 6 is explained in conjunction with elements from FIG. 2, FIG. 3, FIG. 5A, and FIG. 5B.

In various embodiments, the quantizer 222 is configured to receive the one or more separated latent features 230 output from the conditional feature extractor 216, for example the target conditioned latent features 514 shown in FIG. 5B are the one or more separated latent features 230. The quantizer 222 is then configured to discretize the target conditioned features 514 (or the one or more separated latent features 230) into the one or more sequences of code 232. The quantizer 222 may be configured to map continuous latent features into discrete code sequences. The quantizer may include residual vector quantization (RVQ), product quantization, scalar quantization, or other discretization methods. The quantizer 222 may operate with one or more codebooks, which may be shared across source types or domain-specific.

To that end, the quantizer 222 is configured via the stored instructions 204 executed by the processor to discretize the target conditioned features 514 into the one or more sequence of codes 232. The quantizer 222 also includes the stored instructions 204 that implement a residential vector quantization (RVQ) module 602 that is configured to discretize the one or more separated latent features 230, that is the target conditioned features 514, into the discrete code sequences corresponding to the one or more sequence of codes 232. The RVQ module 602 performs multi-stage quantization of a latent feature vector by successively encoding the residual errors left over from prior quantization stages. In some embodiments, the quantizer 222 may implement the RVQ module 602 via the stored instructions 204 that are executed by the processor 206, to produce discrete code sequences corresponding to one or more sequence of codes 232. The one or more sequence of codes 232 is a sequence of discrete tokens, codes, or indices produced by the quantizer 222. A code sequence may represent an individual source, a mixture of sources, or a subset of sources indicated by the one or more prompts 212. The one or more sequence of codes 232 is produced when the RVQ module 602 operates on the target conditioned features 514. The target conditioned features 514 may form a latent feature vector that is used by the RVQ module 602 to generate one or more discrete code indices by iteratively quantizing residual error vectors.

In some embodiments, the RVQ module 602 may include a plurality of quantization stages, where a first stage quantizes the latent vector using a first codebook and each subsequent stage quantizes a residual vector representing the difference between the original latent vector and the cumulative quantized approximation generated by preceding stages. The RVQ module 602 outputs one or more code sequences corresponding to one or more prompts, where each code sequence is itself composed of multiple code sequences. In an embodiment, multiple code indices are stacked together to produce a single “multi-index” code sequence for each of the one or more prompts, which together represent a compressed digital encoding of the latent feature vector suitable for decoding or transmission.

In some embodiments, the quantizer 222 is shared across all prompts in the one or more prompts 212 to reduces complexity compared to domain-specific pathways. Unlike architectures that allocate domain-specific quantizers (e.g., separate for speech or music), a shared quantizer simplifies the design of the audio coding system 202 and reduces memory footprint. Sharing also facilitates joint optimization across sources, enhancing scalability and adaptability.

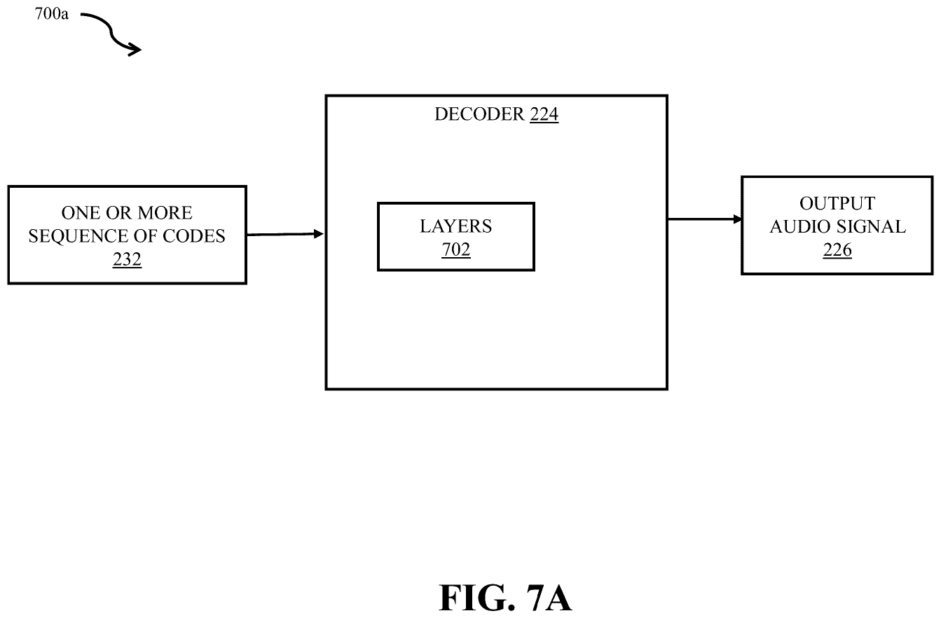

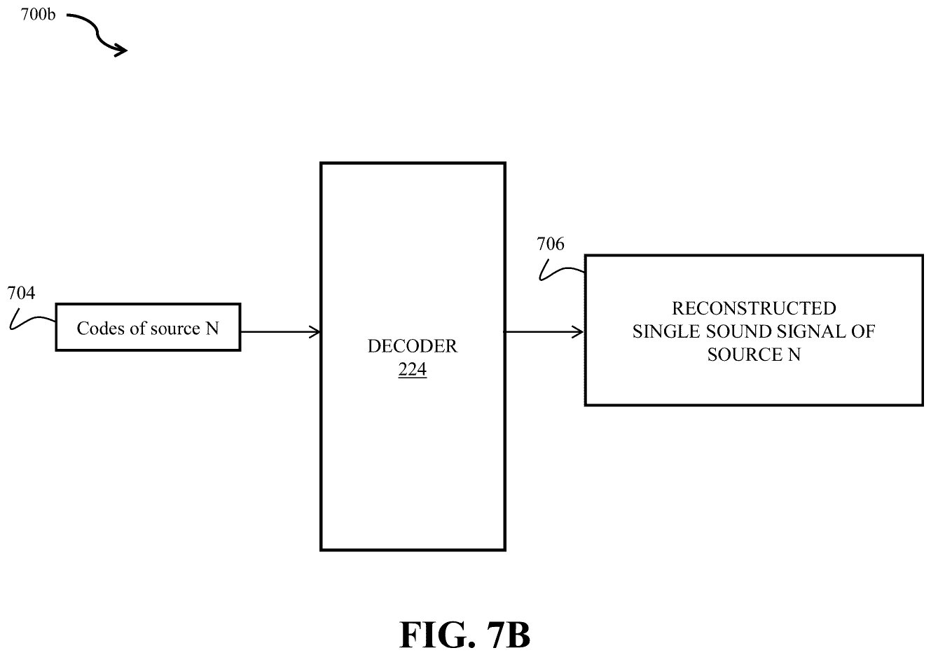

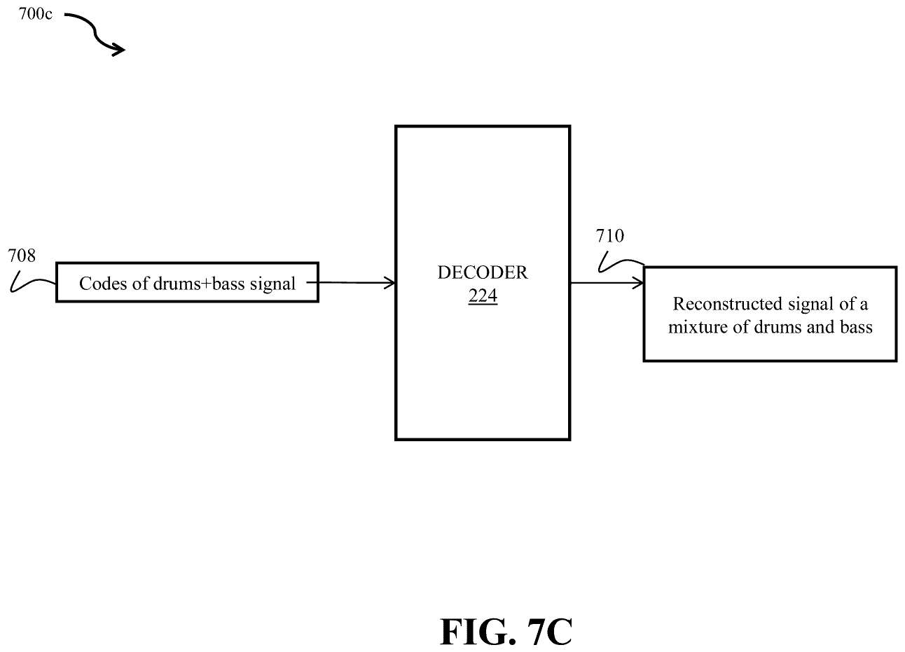

The discrete one or more code sequences 232 generated by the quantizer 222 are then passed to the decoder 224, which is explained in detail in FIG. 7A, FIG. 7B and FIG. 7C.

FIG. 7A illustrates a block diagram 700a showing working of the decoder 224, according to an embodiment of the present disclosure. FIG. 7A is explained in conjunction with elements from FIG. 2, FIG. 3, FIG. 5A, FIG. 5B, and FIG. 6.

The block diagram 700a illustrates the decoder 224 that may be configured via the stored instructions 204 executed by the processor 206, to reconstruct, from the one or more sequence of codes 232, such as from the upstream quantizer 222 and input encoder 214 system, one or more output audio signals 226 corresponding to the one or more of the one or more sound sources indicated by the one or more prompts 212.

To that end, the decoder 224 may include a plurality of layers 702. For example, the plurality of layers include convolutional layers and transformer layers. These plurality of layers 702 is configured to reconstruct the one or more output audio signals 226 from the discrete code sequences provided as input in the form of one or more sequence of codes 232. In some embodiments, the plurality of layers 702 include neural network layers, convolutional layers, transformer layers, recurrent units, up sampling layers, or other computational structures suitable for reconstructing audio signals from discrete code sequences.

In some embodiments, the decoder 224 decoder may include convolutional networks, autoregressive networks, transformers, or generative adversarial models.

In some embodiments, the decoder 224 may combine convolutional up sampling layers with self-attention or transformer blocks. The decoder 224 may reconstruct signals from discrete codes by progressively refining temporal resolution and spectral detail. This architecture balances computational efficiency with reconstruction quality, allowing high-fidelity output audio signal 226 at practical bitrates.

During operation, the decoder 224 receives the one or more code sequence(s) 232, interprets the discrete indices using one or more learned or predefined codebooks, and generates a sequence of decoded latent features or representations. The layers 702 then transform the decoded latent features into a time-domain or frequency-domain audio signal using one or more learned transformations. The resulting signal is provided as the output audio signal 226, which may represent an isolated source, a mixture of sources, or any target audio structure associated with the encoding process.

In some embodiments, the decoder 224 is shared across multiple sound-source types, enabling reconstruction of speech, musical instruments, sound effects (SFX), or other audio categories using a unified model structure.

Further in some embodiments, the decoder 224 shared across all prompts in the one or more prompts 212, thereby avoiding the use of separate domain-specific decoder 224.

An example embodiment of operation of the decoder 224 is shown in FIG. 7B.

FIG. 7B illustrates a block diagram 700b showing working of the decoder 224, according to an embodiment of the present disclosure. As shown in the block diagram 700b of FIG. 7B, the decoder 224 decoder takes a code sequence corresponding to a source N 704 as input and outputs a reconstructed single sound signal of source N 706. Another example embodiment of operation of the decoder 224 is shown in FIG. 7C.

FIG. 7C illustrates a block diagram 700c showing working of the decoder 224, according to an embodiment of the present disclosure. As shown in the embodiment of FIG. 7C, the decoder 224 receives a mixture of multiple sources such as drums+bass. Correspondingly sequence of codes drums+bass signal 708 may be produced by the quantizer 222 of the audio coding system 202. The sequence of codes of the drums+bass signal 708 correspond to discrete indices generated by the quantizer 222 or by multi-stage RVQ module 602 applied to a latent representation of a drums-and-bass mixture The sequence of codes of the drums+bass signal 708 are received by the decoder 224 and a reconstructed signal of mixture of drums and bass signal 710 is produced by the decoder 224.

Thus, the decoder 224 generates an audio signal corresponding to a mixture of multiple sound sources, according to the embodiment shown in FIG. 7C. The decoder 224 may implemented using one or more processors, such as the processor 206 executing the stored instructions 204 maintained in a non-transitory computer-readable memory. The processor 206 interprets the incoming discrete code sequence of the drums+bass signal 708 and applies one or more decoding layers (e.g., neural network layers, upsampling layers, inverse-transform layers, or other reconstruction modules) to generate a corresponding time-domain or frequency-domain audio signal. As illustrated, the decoder 224 produces the reconstructed signal 710 that represents the mixture of drums and bass indicated by the input codes. In some embodiments, the decoder 224 uses shared decoding parameters across multiple types of sound sources or mixtures of sources, enabling a unified reconstruction path regardless of whether the target output corresponds to a single source or a grouped mixture such as the drums+bass signal.

All operations shown in FIG. 7C are conducted automatically by computing hardware, with the decoder 224 performing numerical transformations on machine-encoded inputs.

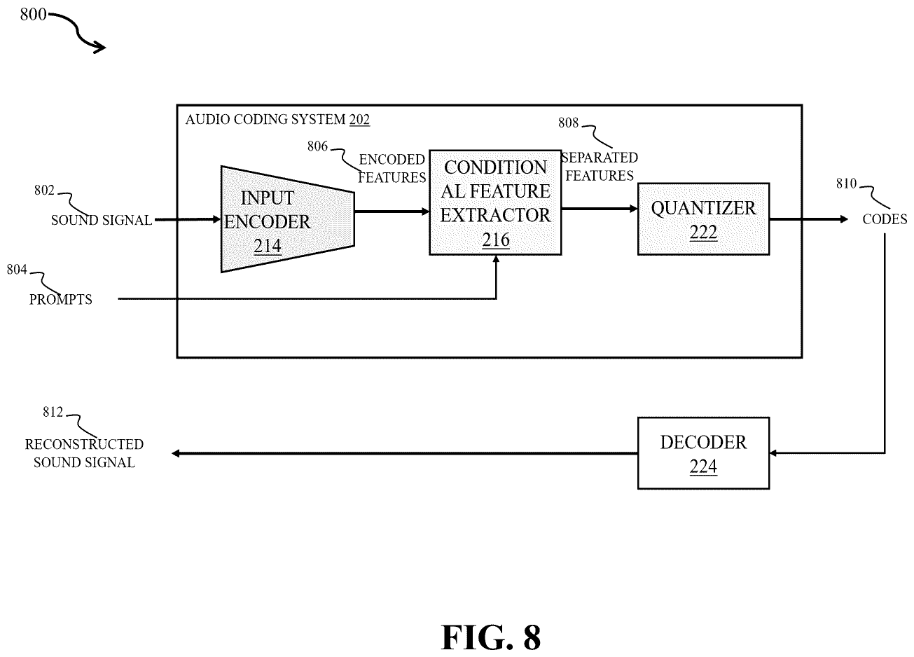

The decoder 224, the quantizer 222 and all other components of the audio coding system 202 described in the various embodiments above may be implemented using different architectures and computational algorithms and corresponding programming languages on a computing device. One such example implementation of the audio coding system 202 is explained in conjunction with FIG. 8 described herein.

FIG. 8 illustrates a schematic diagram 800 showing an example implementation of the audio coding system 202 and its various modules and components, according to an embodiment of the present disclosure. FIG. 8 is explained in conjunction with elements from FIG. 2, FIG. 3, FIG. 5A, FIG. 5B, FIG. 6, FIG. 7A, FIG. 7B, and FIG. 7C. As shown in the schematic diagram 800, the audio coding system 202 includes the input encoder 214, the conditional feature extractor 216, and the quantizer 222. In some embodiments the audio coding system 202 may also include the decoder, as shown in FIG. 2. In the embodiment shown in FIG. 8, the decoder 224 is communicatively coupled to the audio coding system 202.

The audio coding system 202 receives as input a sound signal, which may be a signal corresponding to one or more sound sources. The sound signal 802 may be equivalent to the input audio signal 208 disclosed earlier in FIG. 2. The audio coding system 202 also receives as input one or more prompts 804 corresponding to sound sources to be extracted from the sound signal 802.

In some embodiments, the mixture of sound sources corresponding to the sound signal 802 may be represented as an input waveform

$$x = {\sum }_{n} {s}_{n}^{( {p}_{n} )} ∈ {ℝ}^{L}$$

consisting of N≥1 sources

$${s}_{n}^{( {p}_{n} )} ,$$

each associated with a source type described by a prompt pₙ ∈ [symbol] . As disclosed earlier, the sources may include speech, music, SFX, or a mixture of these, such that [symbol] ={<Speech>, <Music>, <SFX>, <Mix>}. Multiple sources may be of the same type. The audio coding system 202 is configured to extract codes for one or more of these sources, specified by a set of desired prompts, such as the one or more prompts 804. The one or more prompts 804 are equivalent to the one or more prompts 212 described earlier in conjunction with FIG. 2.

The sound signal 802 is passed to the input encoder 214 that maps the input waveform x into a continuous time-frequency (TF)-like representation of encoded features 806, like the latent representation 228 shown in FIG. 2, and denoted as X∈ [symbol] ^{F×T}, where F and T denote the feature dimension and the number of frames. The conditional feature extractor 216 then estimates separated TF-representation of separated features 808 based on the encoded features and the input of the learnable prompts in the form of the one or more prompts 804.

As shown in FIG. 2, FIG. 5A, and FIG. 5B, the conditional feature extractor 216 includes the cross-prompt module 218, the conditioning module 220, and the target-source extraction module 510. The cross-prompt module 218 takes as input the encoded TF representation X∈ [symbol] ^{F×T} and learnable prompt vectors P∈ [symbol] ^{F×N} corresponding to the N prompts (pₙ)ₙ. To enable reconstruction of multi-source mixtures, the audio coding system 202 is trained to reconstruct the mixture as is when <Mix> is supplied. In some embodiments, the N prompts are concatenated to X along the time axis, by applying transformer layers along time, and then splitting off the first N tokens to yield transformed prompts P′∈ [symbol] ^{F×N} and transformed features X′∈ [symbol] ^{F×T}. With positional encoding and self-attention, the one or more prompts 804 with the same content but different positions produce different representations. As a result, the input TF features are influenced by the one or more prompts 804 and mapped into a space that facilitates conditional extraction. The conditioning module 220 applies feature-wise linear modulation (FiLM) with residual connection to the transformed features X′ using each transformed prompt P′ₙ∈ [symbol] ^{F}. Using arbitrary trainable functions f and h implemented as simple linear transformations shared across all prompts, the FILM output is computed as:

$$FiLM ( {X}^{′} \vert {P}_{n}^{′} ) = f ( {P}_{n}^{′} ) ⊙ {X}^{′} + h ( {P}_{n}^{′} ) , \qquad ( 1 )$$

where ⊙ denotes the element-wise product.

In some embodiments, the conditioning module 220 may be configured to execute operations for element-wise multiplication with the prompt broadcast over time.

Further, the target-source extraction module 510 is configured to refine the conditioned TF representation with transformer layers shared across all prompts.

The audio coding system 202 also includes the quantizer 222 and the 224 decoder that are source agnostic, i.e., shared across all sources. The quantizer 222 uses a multi-layer RVQ with projection, such as that performed by the RVQ module 602 shown in FIG. 6, to discretize the separated TF representations or the separated features 808, and to produce codes 810. The codes 810 are equivalent to the sequence of codes 232 shown earlier in FIG. 2. The decoder 224 then takes the quantized TF features in the form of codes 810 and estimates waveforms corresponding to reconstructed sound signal 812 ŝ ∈ [symbol] ^{N×L}, where N is the number of prompts provided to the conditional feature extractor. As disclosed earlier, the decoder 224 may include a combination or plurality of layers 702, such as transformer and convolutional layers.

At inference time operation of the audio coding system 202, the reconstructed sound signal 812, which is equivalent to the output audio signal 226 shown in FIG. 2, may be used in downstream tasks such as transcription, captioning, audio classification, selective audio enhancement, AR/VR applications, teleconferencing, smart home assistant, audio streaming/broadcasting applications, and the like.

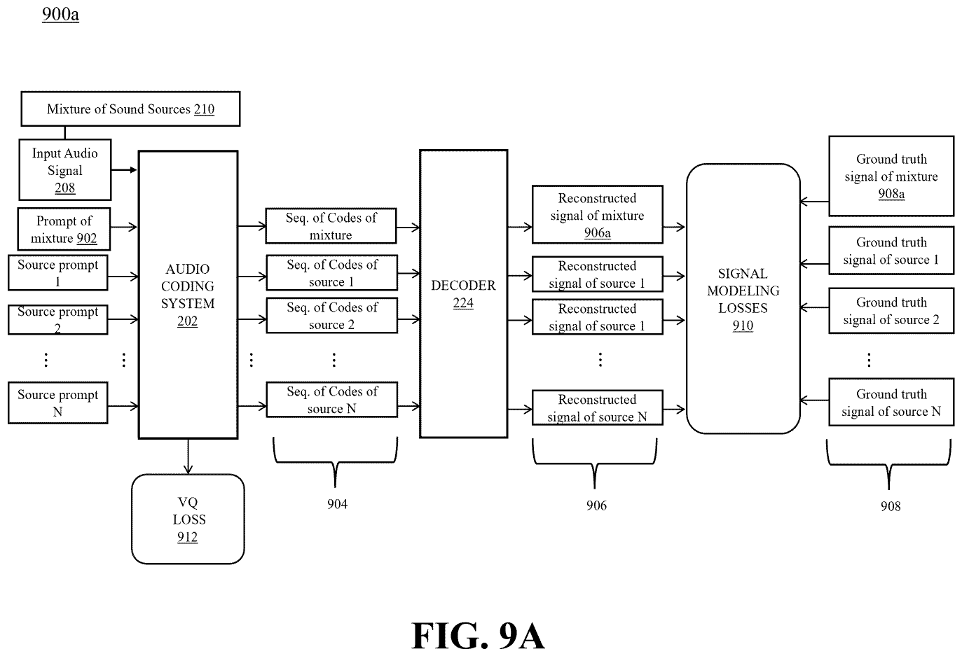

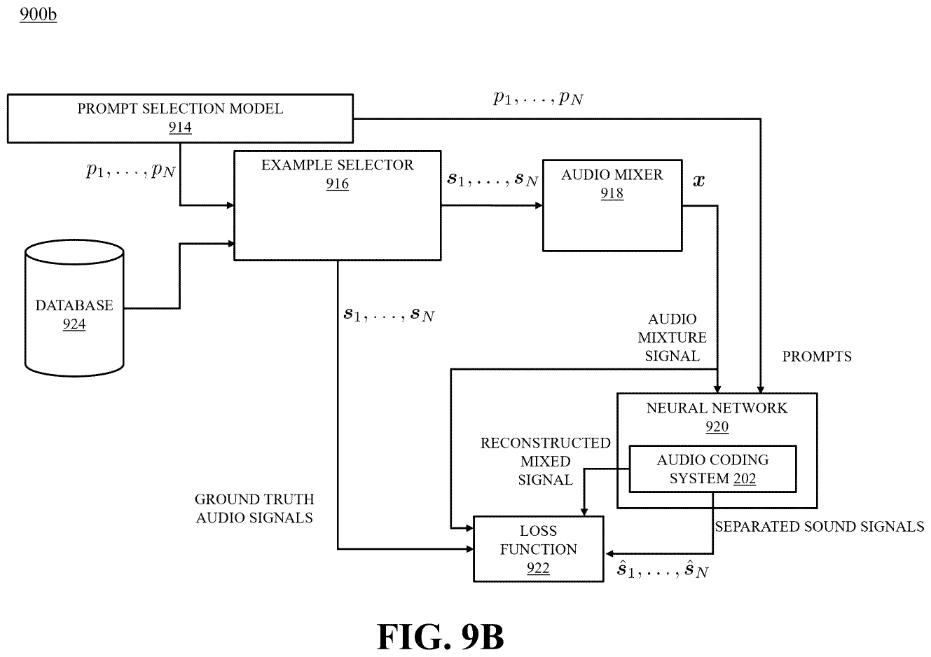

At training time operation of the audio coding system 202, the reconstructed sound signal 812 may be used to compute reconstruction and/or signal losses, and to jointly train one or a combination of the various components of the audio coding system 202, such as the input encoder 214, the conditional feature extractor 216, the quantizer 222, the decoder 224, and the one or more prompts 804 (as they are learnable prompts). The training of the audio coding system 202 and its various components is explained in conjunction with FIG. 9A and FIG. 9B.

FIG. 9A and FIG. 9B collectively illustrate training of the audio coding system 202 according to an embodiment of the present disclosure. FIG. 9A and FIG. 9B are explained in conjunction with elements from FIG. 2, FIG. 3, FIG. 5A, FIG. 5B, and FIG. 8.

During training of the audio coding system 202 as illustrated in FIG. 9A, a plurality of audio modeling losses may be used to train the audio coding system 202. The audio modeling losses may include, without limitation, spectral reconstruction losses, discriminative/adversarial losses, and feature-matching losses between the ground-truth and reconstructed signals. A discriminator operating on the ground-truth and reconstructed signals may also be trained, and its outputs may be used to define loss terms within a GAN framework, as shown by a signal modeling losses 910 calculator in FIG. 9A. Another loss used during the training of the audio coding system 202 may be a VQ loss 912 which includes metrics computed in the quantizer 222, such as the codebook and commitment losses.

To that FIG. 9A illustrates an example block diagram 900a of a system architecture for training or evaluating the audio coding system 202 configured to generate source-aware neural audio codes, according to an embodiment of the present disclosure. The illustrated architecture includes modules executed by one or more processors, such as the processor 206, operating on digital audio signals and latent feature representations stored in a non-transitory memory, such as in the form of stored instructions 204.

The audio coding system 202 receives the mixture of sound sources 210 which is transformed into the input audio signal 208 that is provided as input to the audio coding system 202. As discussed earlier, the mixture of sound sources 210 may include two or more sound sources, such as speakers, musical instruments, sound effects, or other acoustic events. A corresponding prompt of mixture 902 is also provided as input to the audio coding system 202, together with source prompts 1 through N, each identifying or indicating a respective sound source present in the mixture of sound sources 210. These mixture and source prompts are digital input signals used to condition feature extraction and quantization operations of the audio coding system 202.

The audio coding system 202 receives the input audio signal 208 and the plurality of prompts and generates a set of codes of mixture and codes of source 1 through codes of source N, as shown at block 904. The audio coding system 202 may implement the input encoder 214, the conditional feature extractor 216, the quantizer 222, and other components described previously. The audio coding system 202 may also compute the vector quantization (VQ) loss 912, used during training to optimize codebook assignment, residual vector quantization stages, or quantizer operation. This VQ loss 912 forms part of the machine-learning optimization objective and is evaluated using processor-executed numerical operations.

The generated code sequences at block 904 are provided to the decoder 224, which reconstructs digital audio signals from the discrete code indices. As illustrated at block 906, the decoder 224 produces a reconstructed signal of mixture 906a and reconstructed signals of source 1 through source N. The decoder 224 may include one or more neural network layers, upsampling layers, or other reconstruction architectures that transform the discrete code sequences into time-domain or frequency-domain audio signals, as already described earlier in conjunction with FIG. 7A, FIG. 7B, and FIG. 7C.

The reconstructed signals are compared against corresponding ground truth signals at block 908. Specifically, the audio coding system 202 receives a ground truth signal of mixture 908a and ground truth signals of source 1 through source N, which represent the target signals used to evaluate or train the source-aware audio coding system 202.

Based on the reconstructed signals on the block 906 and the ground truth signals at the block 908, the signal modeling losses calculator 910 computes one or more signal-domain errors between the reconstructed signals and their respective ground truth signals. The signal modeling losses may include waveform-domain loss functions, spectral-domain loss functions, perceptual similarity losses, multi-resolution STFT losses, or other machine-learning loss functions. These losses form part of the end-to-end training objective for optimizing the input encoder 214, the conditional feature extractor 216, the quantizer 222, and the decoder 224, or other components of the audio coding system 202.

The overall architecture shown in FIG. 9A demonstrates how the system processes mixture and source prompts, generates both mixture-level and source-level codes, reconstructs corresponding audio signals, and computes losses to refine the audio coding system 202 through supervised or semi-supervised learning.

In some embodiments, the audio coding system 202 is trained via a permutation invariant training (PIT) training algorithm that may compute a training loss by associating the generated sources with the ground truth sources in an optimal way. Because of use of the PIT training algorithm, the audio coding system 202 is made more robust, as the audio coding system 202 is trained by evaluating all possible permutations of correspondences between the reconstructed signals and the ground truth source signals, and selecting the permutation that yields the minimum loss. By using permutation-invariant training, the audio coding system 202 learns to disentangle or separate sources without requiring a predetermined output ordering, which is specifically advantageous for separating multiple sources of same type of class, such as multiple speakers corresponding to <Speech>prompt, multiple types of drums corresponding to <Drums>prompt, and the like. In some embodiments, PIT is applied to the output of the conditional feature extractor 216, the quantizer 222, and/or the decoder 224 to train the audio coding system 202 to separate multiple sources of a same category using shared processing modules. One example implementation of a training procedure for training the audio coding system 202 is shown in FIG. 9B.

FIG. 9B illustrates a block diagram 900b showing an example training procedure for training the audio coding system 202, according to an embodiment of the present disclosure.

To prepare a training sample, a number N of sources is randomly selected between certain values (e.g., between 1 and 4) with some probability, then N prompts are randomly selected by a prompt selector model 914 following certain rules. Given the selected prompts, N audio samples are randomly sampled from a database 924 by an example selector 916, such that the N audio samples are determined by the type of each prompt. The sampled audio samples are used to create a mixture by an audio mixer 918, this mixture is used as input to a neural network 920 implementing the functionality of the audio coding system 202. The sampled prompts are also given as input to the neural network 920. Based on the input mixture and the prompts, the audio coding system 202 outputs N separated sound signals, which are used, together with the N sampled audio signals used as ground-truth audio signals to compute a loss function 922 for training. In some embodiments, repetition of multiple prompts of the same category is done, for example “<speech>, <speech>”, such that the part of the loss function that is computed on the outputs of the audio coding system 202 and the ground-truth signals corresponding to these repeated prompts is computed using permutation-invariant training, meaning that all permutations of the ground-truth signals when comparing them with the output separated sound signals are allowed and finally the permutation leading to the minimum loss is selected to compute the loss function 922. Separated sound signals and ground-truth signals corresponding to prompts that are not repeated are directly compared which each other.

As used for training, the database 924 may store a plurality of audio recordings of sound sources, including single-source signals, grouped-source signals, and mixtures of sources. These recordings serve as selectable training elements for generating supervised or semi-supervised learning examples. The prompt selection model 914 outputs a set of prompts designated as p₁, . . . , p_{N}, where each prompt corresponds to one or more sound source categories (e.g., speech, music, SFX, drums, bass, vocals, mixtures thereof). In some embodiments, the prompt selection model 914 may be a rule-based model, a statistical model, or a machine-learned model that determines which prompts are to be used for each training iteration.

In some embodiments, the prompts p₁, . . . , p_{N} are provided to the example selector 916, which is configured to select from the database 924, the set of ground truth audio signals s₁, . . . , s_{N} corresponding to the indicated prompt categories. The example selector 916 may retrieve individual audio tracks, instrument/voice stems, or single-source recordings matching the prompt semantics.

The selected sources s₁, . . . , s_{N} are provided to the audio mixer 918, which generates the audio mixture signal x by computationally mixing the selected audio signals. The mixture operation may include sample-wise addition, scaling, gain normalization, spatial mixing, or other digital audio mixing procedures. The audio mixture signal is provided to the neural network 920, which implements all or part of the audio coding system 202. The neural network 920 receives (i) the audio mixture signal x and (ii) the prompts p₁, . . . , p_{N}. Based on these inputs, the neural network 920 generates separated sound signals ŝ₁, . . . , ŝ_{N} corresponding to the sound sources indicated by the prompts. In some embodiments, the neural network 920 includes an encoder, a conditional feature extractor, a quantizer, and a shared decoder configured as described elsewhere in this disclosure.

The reconstructed mixture signal or reconstructed source signals are passed to the loss function module 922, which computes one or more loss values that may include waveform-domain losses, spectral losses, multi-resolution STFT losses, perceptual similarity losses, or combinations thereof. The computed loss values are used for updating the parameters of the neural network 920, the prompt selection model 914, or the example selector 916 during the training process. The system architecture shown in FIG. 9B supports the generation of training examples that reflect realistic mixture conditions and enables the audio coding system 202 to learn to separate, encode, and reconstruct source-specific audio representations using prompts as conditioning inputs. All operations illustrated in FIG. 9B are performed by processor-executed modules manipulating digital audio data.

An example of operations and calculations executed by the different modules of the audio coding system 202 to perform the training as described in FIG. 9A and FIG. 9B is as given below.

In some embodiments, the audio coding system 202 may be trained with a permutation-invariant objective given as:

$${ℒ}_{SUNAC} = {min}_{π ∈ {\tilde{𝒫}}_{S}} {\sum }_{i = 1}^{S} {ℒ}_{DAC} ( {s}_{i} , {\hat{s}}_{π ( i )} ) + {ℒ}_{DAC} ( {s}_{mix} , {\hat{s}}_{mix} ) , \qquad ( 2 )$$

where sᵢ and ŝ_{π(i)} are the i-th ground-truth source and its assigned estimate, while sₘᵢₓ and ŝₘᵢₓ are the ground-truth and estimated mixtures, S is the number of sources, and \tilde{P}ₛ is the subset of permutations of {1, . . . , S} that only permute indices corresponding to prompts of the same type, leaving others fixed; π∈\tilde{P}ₛ can thus align, e.g., multiple <Speech>estimates to their appropriate references. L_{DAC} denotes the DAC loss, which consists of a weighted sum of multi-scale mel-spectrogram loss, adversarial loss, codebook loss, commitment loss, and discriminator loss. The discriminator consists of a multi-period discriminator and a complex multi-scale STFT discriminator. The entire audio coding system 202 is trained in a generative adversarial manner.

In operation, evaluating all components of the DAC loss over all permutations is computationally prohibitive. Instead, the permutation is determined using a scale-invariant signal-to-distortion ratio (SI-SDR)-based criterion and the DAC loss is computed only for the output-reference assignment that minimizes this SI-SDR criterion as follows:

$${π}^{★} = arg {max}_{π ∈ {\tilde{𝒫}}_{S}} {\sum }_{i = 1}^{S} SI - SDR ( {s}_{i} , {\hat{s}}_{π ( i )} ) \qquad ( 3 )$$

$${ℒ}_{SUNAC} = {\sum }_{i = 1}^{S} {ℒ}_{DAC} ( {s}_{i} , {\hat{s}}_{{π}^{★} ( i )} ) + {ℒ}_{DAC} ( {s}_{mix} , {\hat{s}}_{mix} ) \qquad ( 4 )$$

where π* denotes the optimal permutation of the estimated signals with respect to the reference sources, restricted to permutations among sources of the same type (cross-type indices fixed).

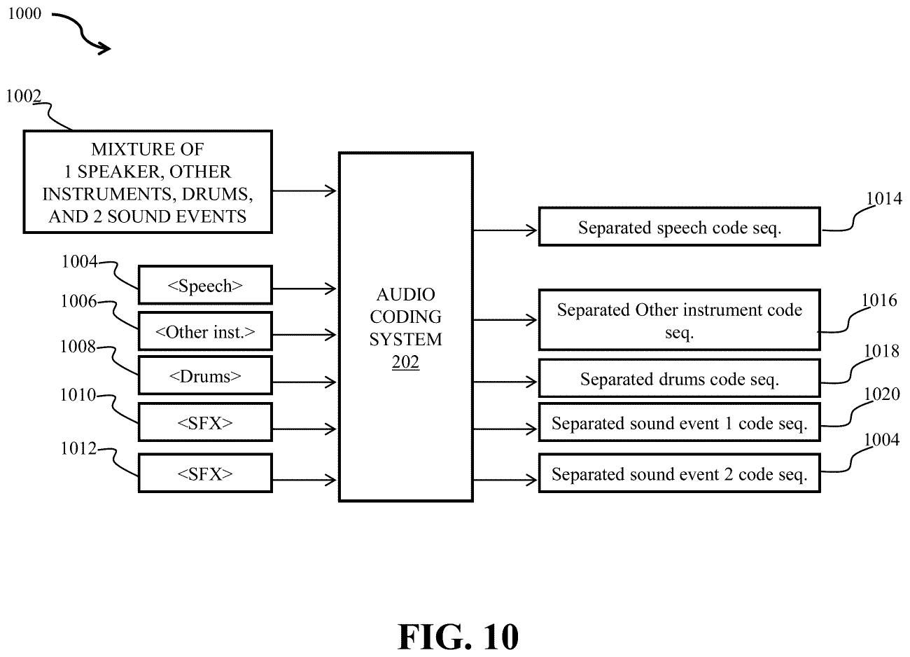

Thus, using the training methodologies and optimization objectives described in conjunction with FIG. 9A and FIG. 9B above, the audio coding system 202 may trained efficiently, robustly, and to perform accurate audio coding, separation, and enhancement tasks, which may be used in a variety of downstream applications. In some embodiments, the audio coding system 202 is trained so robustly that it can perform well even when encountering prompts never seen during training. This is illustrated in FIG. 10.

FIG. 10 illustrates a block diagram 1000 of the audio coding system 202 showing an example use case of operation with combinations of prompts never seen during training, according to an embodiment of the present disclosure.

In the embodiment shown in FIG. 10, the audio coding system 202 receives a mixture of sound sources 1002 including a speaker, other instruments, drums, and two sound events. The audio coding system 202 may be trained, as an example, with a maximum of 4 prompts. However, as seen in FIG. 10, during operation at inference time, it may receive 5 prompts—a <speech>prompt 1004, an <other>instrument prompt 1006, a <drums>prompt 1008, an <SFX>prompt 1010, and an <SFX>prompt 1012. Because of the training of the audio coding system 202 as described in FIG. 9A and FIG. 9B, the audio coding system 202 can easily handle all the 5 prompts and provide output, five separated sources corresponding to a separated speech code sequence 1014, a separated other instrument code sequence 1016, a separated drums code sequence 1018, a separated sound event 1 code sequence 1020, and a separated sound event 2 code sequence 1022.

It may be understood that the number of prompts mentioned in the description of FIG. 10 is only for example purpose. Any equivalent number of prompts and separated sources may be equivalently managed by the audio coding system 202, without deviating from the scope of the present disclosure.

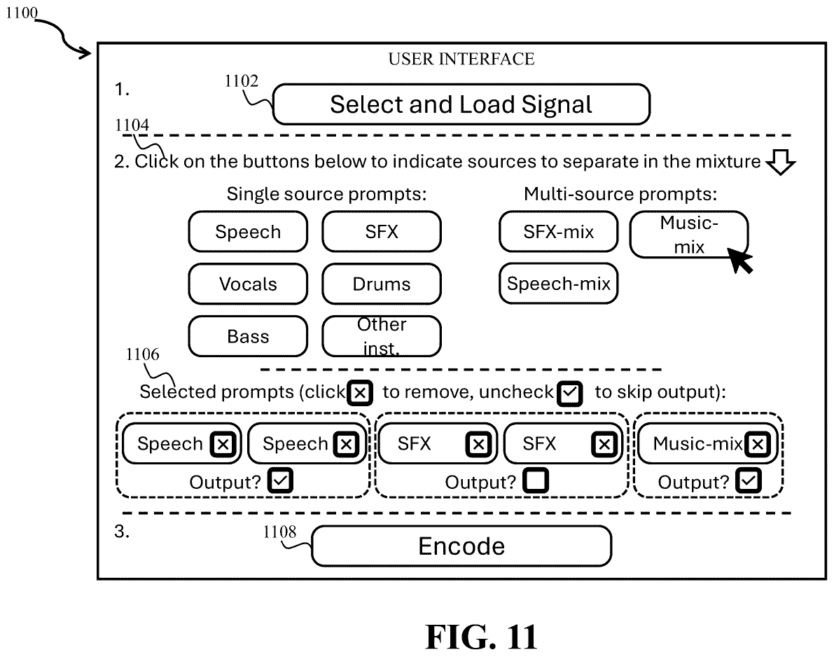

In some embodiments, the audio coding system 202 may include an interactive user interface that may enable interaction with or sending input and receiving output from the audio coding system 202. Such a user interface is described in conjunction with FIG. 11.

FIG. 11 illustrates a schematic diagram of an example user interface 1100 of the audio coding system 202, according to an embodiment of the present disclosure. FIG. 11 is explained in conjunction with all the preceding embodiments, and more specifically in conjunction with elements of FIG. 2.

The audio coding system 202 may be implemented as a computing device that include the user interface 1100. The user interface 1100 enables the user to first select and load a mixture of audio signal, then select a variable number of prompts that are present in the mixture, with the option to choose whether the corresponding source or group of sources should be output by the audio coding system 202, or if the prompt is only used to indicate context; then the user can instruct the audio coding system 202 to separate the sources as indicated.

To perform the functionality of the user interface 1100 as described above, the user interface 1100 may be a part of a prompt input interface.

In some embodiments, the user interface 1100 includes a plurality of display options. A first option is provided by a first UI element 1102, where a user can first select and load a mixture of sound sources corresponding to an input audio signal. For example, the mixture of sound sources 210 may be loaded into the audio coding system 202 using the first UI element 1102.

A second option is a second UI element 1104 that allows the user to select prompts corresponding to the desired sources to separate. The second UI element 604 displays a plurality of prompts that can be selected by the user such as speech, SFX, vocals, and the like. These displayed prompts correspond to the set of possible sound prompts from which the sound prompts in the input set of sound prompts 106 discussed earlier can be selected. Out of these, the user may then select a variable number of sound prompts that are present in the loaded audio mixture. A same prompt such as Speech or SFX may be selected multiple times if multiple sources of that type are deemed to be present in the audio mixture by the user. For example, the one or more prompts 212 may be selected using the second UI element 1104.

The prompts which user selects are displayed by a third UI element 1106 and are considered as input sound prompts and form the set of one or more prompts 212. In some embodiments, the user may further select which of the corresponding sources to output by checking a box next to the corresponding sound prompts in the third UI element 1106. The prompts selected for source output are considered as target sound prompts and form the target set of sound prompts. Further, when the user clicks on a fourth UI element 1108, the audio processing system 202 is triggered at the backend, and the process and/or method of generating the sequence of codes 232 or the separated sound sources 234 is executed, as per the various embodiments described above.

In some embodiments, the audio processing system 102 may be configured to perform diverse tasks. Some of these are discussed in the following figures.

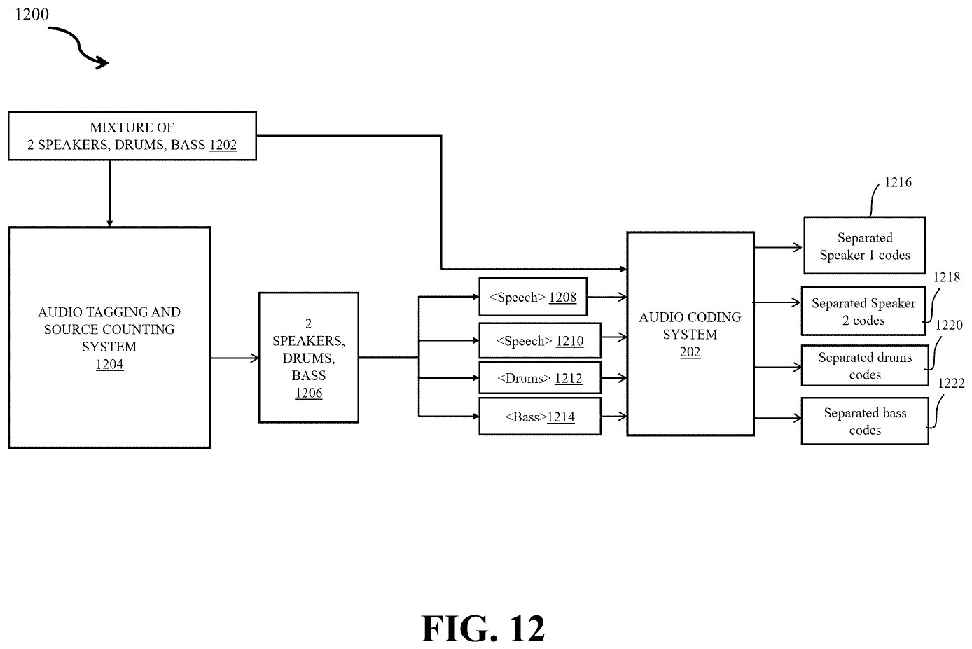

FIG. 12 illustrates a block diagram 1200 of the audio coding system 202 configured to automatically identify sound sources in an audio mixture and to generate corresponding source-aware neural audio codes without requiring a user to manually specify the number or type of sources, according to an embodiment of the present disclosure.

A mixture of sound sources 1202 (e.g., a mixture containing two speakers, drums, and bass) is provided as input to an audio tagging and source counting system 1204. The audio tagging and source counting system 1204 is implemented by one or more processors executing stored instructions and is configured to analyze the input audio mixture using machine-learning-based tagging, detection, and classification models. Based on this analysis, the audio tagging and source counting system 1204 determines (i) the number of distinct sound sources present in the mixture and (ii) the type or category of each source (e.g., “Speech,” “Drums,” “Bass”). The audio tagging and source counting system 1204 outputs a list of detected sources 1206, which may include explicit source labels or identifiers for each sound source detected.

The detected source list 1206 is used to produce a corresponding set of prompts 1208-1214, where each prompt encodes conditioning information for a specific source type. For example, prompt 1208 may correspond to a first speech source, prompt 1210 to a second speech source, prompt 1212 to drums, and prompt 1214 to bass. In some embodiments, each prompt is represented as a learnable embedding vector or machine-interpretable signal that guides the downstream audio coding system.

The audio coding system 202 receives both the original mixture signal 1202 and the automatically generated prompts 1208-1214. Based on these inputs, the audio coding system 202 performs prompt-conditioned feature extraction, quantization, and encoding operations, as previously described with respect to FIGS. 3, 5A-5B, and 7. The audio coding system 202 generates a corresponding set of separated code sequences, including separated speaker 1 codes 1216, separated speaker 2 codes 1218, separated drums codes 1220, and separated bass codes 1222. Each code stream represents a compressed, source-specific neural audio code suitable for decoding or downstream processing.

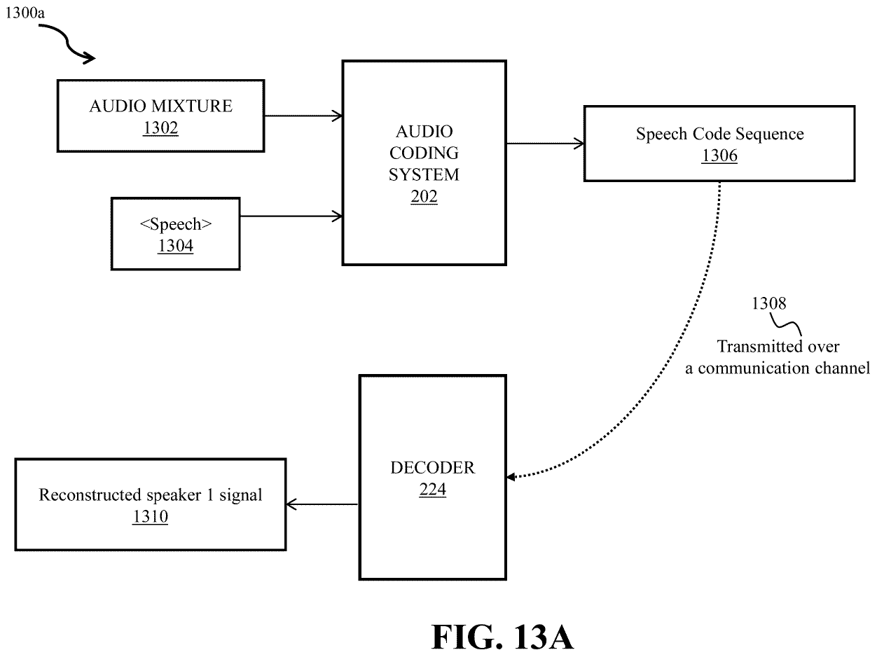

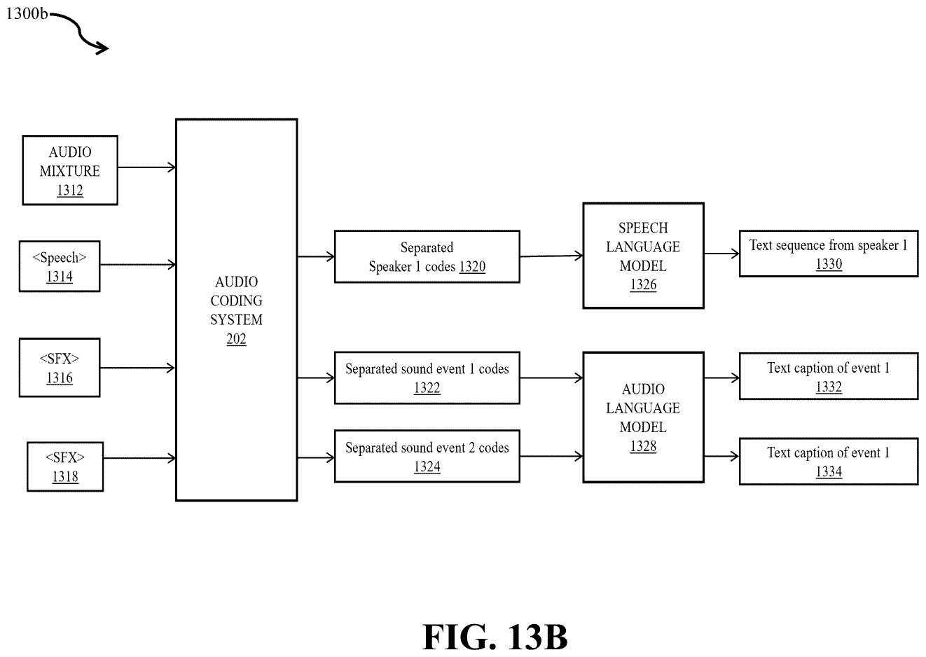

The system architecture shown in FIG. 12 demonstrates how the present embodiments of the audio coding system 202 provide an automatic full-source separation and source-aware coding system, without requiring any manual specification by the user. Instead, the audio tagging and source counting system 1204 automatically infers the source composition of any given mixture and generates the appropriate prompts to condition the audio coding system 202. This enables a fully automated pipeline for producing source-aware neural audio codes corresponding to all sources detected in the input mixture. All components shown in FIG. 12 operate using processor-executed instructions applied to digital audio signals stored in a non-transitory memory. Some other example applications of the audio coding system 202 is shown in FIG. 13A and FIG. 13B.

FIG. 13A illustrates a block diagram 1300a showing an example use case of implementation of the audio coding system 202, according to an embodiment of the present disclosure. As shown in the embodiment of FIG. 13A, the audio coding system 202 may receive an audio mixture 1302 including audio signals of multiple audio sources. The audio mixture 1302 may be equivalent to the mixture of sound sources 210 disclosed in previous embodiments. The audio mixture 1302 is transformed into an audio signal, as disclosed earlier for the input audio signal 208, and provided as input to the audio coding system 202. The audio coding system 202 also receives as input, a speech prompt 1304, indicating that from the audio mixture 1302, speech corresponding to one or more speakers needs to be encoded.

The audio coding system 202 then processes the audio signal of the audio mixture 1302 and the speech prompt 1304, through various modules implemented as computer executable stored instructions 204, such as the input encoder 214, the conditional feature extractor 216, the and the quantizer 222, to provide as output a discrete code sequence corresponding to speech of speaker 1. This discrete code sequence may be designated herein as a separated speaker 1 code 1306. The audio coding system 202 may be further configured via one or more processors, such as the processor 206, to provide the separated speech code sequence 1306 as an output of the audio coding system 202. The separated speech code sequence 1306 may then be used by a downstream machine learning model for a downstream task, such as audio transcription, captioning, audio classification, and the like.

In some embodiments, the downstream machine learning mode may be remote, but communicatively coupled to the audio coding system 202. To that end, the separated speech code sequence 1306 may be transmitted 1308 over a communication channel to a downstream decoder, which may be equivalent to the decoder 224 disclosed in previous embodiments, but connected remotely to the audio coding system 202 and its components including—the input encoder 214, the conditional feature extractor 216, the and the quantizer 222.

The decoder 224 then reconstructs a speaker 1 signal 1310 from the separated speaker 1 code and provides the reconstructed speaker 1 signal 1310 to the downstream machine learning model to execute the downstream task. In an example, the downstream task may be to perform text captions based on received audio mixture signal. Such a scenario is explained in FIG. 13B.

FIG. 13B illustrates a block diagram 1300b of an example application of the audio coding system 202, according to an embodiment of the present disclosure. As shown in the block diagram 1300b, the audio coding system 202 generates source-aware neural audio codes that are subsequently processed by language models to produce text-based descriptions or transcripts, according to an embodiment of the present disclosure.

An audio mixture 1312, which may include multiple sound sources such as speech and sound effects (SFX), is provided as input to the audio coding system 202. A set of prompts is also supplied to the audio coding system, including a speech prompt 1314 and SFX-related prompts 1316 and 1318, each indicative of a respective sound source or sound event expected to be present in the audio mixture 1312. The set of prompts may include prompts, like the speech prompt 1314 or the SFX prompts 1316 and 1318, that are learnable embeddings or machine-interpretable conditioning vectors.

Based on the input mixture 1312 and the set of prompts 1314-1318, the audio coding system 202 generates separated neural audio codes or code sequences for each indicated source. As shown, the audio coding system 202 outputs separated speaker 1 codes 1320, separated sound event 1 codes 1322, and separated sound event 2 codes 1324, each representing a compressed, source-specific code sequence generated using the prompt-conditioned feature extraction and quantization techniques described herein.

The separated codes corresponding to speech (e.g., separated speaker 1 codes 1320) are provided to a speech language model 1326, which is configured to decode or interpret speech-related neural audio codes to produce a corresponding text sequence from speaker 1 1330. The speech language model 1326 may include automatic speech recognition (ASR) layers, transformer-based decoding layers, or other sequence-to-text modules trained to map source-specific neural audio codes to textual content.

Similarly, the separated codes corresponding to non-speech acoustic events (e.g., sound effects) are provided to an audio language model 1328. The audio language model 1328 processes the separated sound event 1 codes 1322 and separated sound event 2 codes 1324 to generate text captions of event 1 1332 and text captions of event 2 1334, respectively. These captions may describe the type of sound event, its temporal characteristics, semantic meaning, or other contextual information.

The architecture of FIG. 13B demonstrates how the audio coding system 202 may be used in a variety of downstream tasks such as speech-to-text, audio captioning, or event-level transcription tasks by providing clean and source-specific neural audio code sequences rather than requiring a language model to interpret complex mixtures.

The audio coding system 202 is thus advantageous in large scale audio applications while providing the ability to select which sources are encoded, which in turn can reduce unnecessary information and allow downstream tasks to receive only what they require.

Further, neural audio codes generated by the audio coding system 202 operate within a latent feature space to perform separation and disentanglement without requiring an explicit front-end separation model. Such integration can reduce redundant computations relative to cascaded systems and permit end-to-end optimization of compression and separation.

Further, as disclosed in some embodiments, the audio coding system 202 may be trained with permutation-invariant training (PIT) to address assignment ambiguities when multiple sources of the same type are present. PIT enables the audio coding system 202 to align outputs with references regardless of source order, thereby allowing reconstruction of multiple speech signals or multiple sound events of the same class. This training strategy can be advantageous in scenarios that previously posed difficulties for domain-specific codecs.

Also, as disclosed in some embodiments the audio coding system 202 may employ a shared residual vector quantization (RVQ) module and decoder across all sources. This design avoids the need for separate, domain-specific quantizers while reducing parameter count and model complexity. Sharing quantization pathways can further enable generalization across domains and allow the codec to support arbitrary combinations of sources encountered at inference.

The audio coding system 202 also provides generalization beyond training conditions. For instance, as disclosed in some embodiments, although the audio coding system 202 may be trained with mixtures containing up to three or four sources, the prompt-based design may allow it to manage larger numbers of sources at inference. In addition, combinations of prompts not encountered during training may still be processed effectively, allowing the audio coding system to adapt to unforeseen real-world mixtures. This capacity for generalization can be advantageous for robustness and deployment in varied environments.

The effects and benefits of various embodiments disclosed above include reduced computational cost, by eliminating redundant operations; improved flexibility, by supporting arbitrary and unseen combinations of sources; and enhanced downstream utility, by providing disentangled and interpretable token streams for use in applications such as speech recognition and multimodal models. Additional advantages may include scalability, as the audio coding system 202 does not impose a fixed limit on the number or types of sources; and consolidation, as one model can support conventional coding, target source extraction, multi-source coding, and mixture reconstruction.

Taken together, these embodiments illustrate how integrating source awareness directly into codec design, as provided by the audio coding system 202, provide beneficial technical effects relative to conventional systems. By leveraging prompt-based conditioning, unified feature extraction, permutation-invariant training, and shared quantization pathways, embodiments of the disclosed system can provide efficient, flexible, and scalable source-aware neural audio coding.

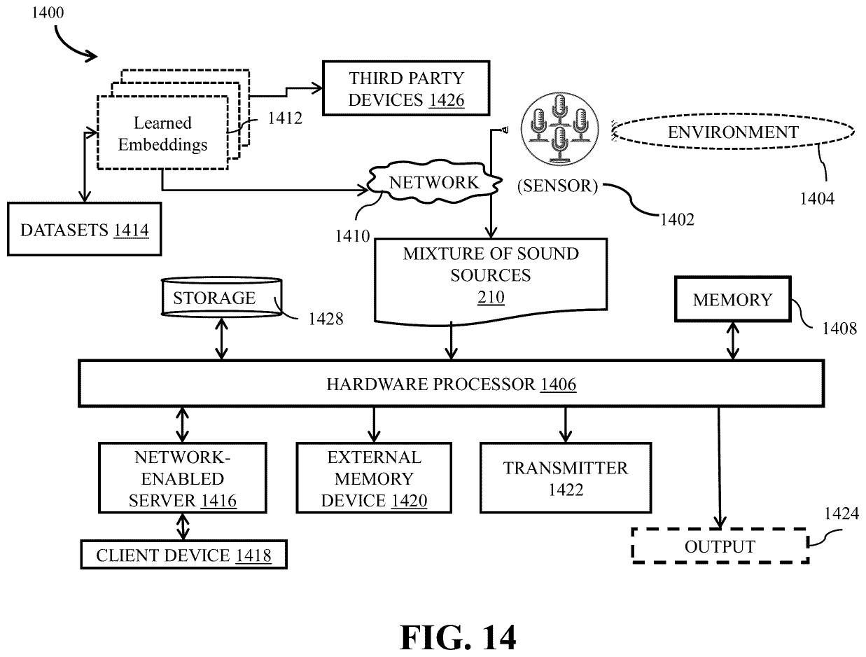

FIG. 14 is a block diagram of a computing system 1400 that is used to implement the audio coding system 202 for performing source aware neural audio code generation, according to embodiments of the present disclosure. In some example embodiments, the block diagram 1000 includes an acoustic sensor 1402 or sensors that collect data including the mixture of sound sources 210 from an environment 1404.

The audio coding system 202 includes a hardware processor 1406. The hardware processor 1406 is in communication with a computer storage memory, such as a memory 1408. The memory 1408 includes stored data, including algorithms, instructions and other data that is implemented by the hardware processor 1406. It is contemplated that the hardware processor 1406 includes one or more hardware processors depending upon the requirements of the specific application. The two or more hardware processors is either internal or external. The audio coding system 202 is incorporated with other components including output interfaces and transceivers, among other devices.

In some alternative embodiments, the hardware processor 1406 is connected to a network 1410, which is in communication with one or more sources to receive learned embeddings 1412 corresponding to the one or more prompts 212. The learned embeddings 1412 may be obtained from one or more datasets 1414. The network 1410 includes but is not limited to, by non-limiting example, one or more local area networks (LANs) and/or wide area networks (WANs). The network 1410 also includes enterprise-wide computer networks, intranets, and the Internet. The audio coding system 202 includes one or more client devices, storage components, and data sources. Each of the one or more client devices, storage components, and data sources comprise a single device or multiple devices cooperating in a distributed environment of the network 1410.

In some other alternative embodiments, the hardware processor 1406 is connected to a network-enabled server 1416 connected to a client device 1418. The network-enabled server 1416 corresponds to a dedicated computer connected to a network that run software intended to process client requests received from the client device 1418 and provide appropriate responses on the client device 1418. The hardware processor 1406 is connected to an external memory device 1412 that stores all necessary data used by the audio coding system 202, and a transmitter 1422. The transmitter 1422 helps in transmission of data between the network-enabled server 1416 and the client device 1418. Further, an output 1424 for one or more separated sequence of codes corresponding to the one or more prompts 212 and the mixture of sound sources 210 sources is generated.

The audio coding system 202 also includes third party devices 1426, which comprise of any type of computing device, such as automatic speech recognition (ASR) system. For example, the third-party devices include but not limited to a computer device, or a mobile device. The mobile device includes but is not limited to a personal data assistant (PDA), a smartphone, smart watch, smart glasses (or other wearable smart device), augmented reality controller headset, a laptop, a tablet, a remote control, an entertainment system, a vehicle computer system, an embedded system controller, an appliance, a home computer system, a security system, a consumer electronic device, or other similar electronics device. In addition, the mobile device includes but is not limited to a microphone or line-in for receiving audio information, or a communication component (e.g., Wi-Fi functionality) for receiving such information from another source, such as the Internet.

Additionally, the audio coding system 202 stores the input data in the storage 1428. The storage 1428 stores information including data, computer instructions (e.g., software program instructions, routines, or services).

The storage 1428 may include stored instructions 204 implementing the various modules of the audio coding system 202, including, but not limited to—the input encoder 214, the conditional feature extractor 216, the quantizer 222, and the decoder 224.

Thus, the computing system 1400 may implement all the functionalities and advantages of the audio coding system 202 described in various embodiments above, without deviating from the scope of the present disclosure.

The above description provides exemplary embodiments only and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as outlined in the appended claims.

Specific details are given in the above description to provide a thorough understanding of the embodiments. However, understood by one of the ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail to avoid obscuring the embodiments. Further, like reference numbers and designations in the various drawings indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware, or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of several suitable programming languages and/or programming or scripting tools and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described concerning certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. An audio coding system, the audio coding system comprising a processor coupled with stored instructions that, when executed by the processor, run modules of the audio coding system, the modules comprising:
an input encoder configured to receive an input audio signal comprising a mixture of one or more sound sources and to generate a latent representation of the input audio signal;
a conditional feature extractor configured to receive the latent representation and one or more prompts indicative of one or more of the one or more sound sources in the mixture, and to generate, based on the one or more prompts, one or more separated latent features corresponding to the one or more sound sources corresponding to at least some of the one or more prompts;
a quantizer configured to discretize the one or more separated latent features into one or more sequences of codes; and
a decoder configured to reconstruct, from the one or more sequences of codes, one or more output audio signals corresponding to the one or more sound sources indicated by the at least some of the one or more prompts.

2. The audio coding system of claim 1, wherein the one or more prompts comprise tokens indicative of one or more source categories, including speech, music, sound effects, environmental sounds, and acoustic events.

3. The audio coding system of claim 1, wherein the conditional feature extractor comprises a cross-prompt module configured to jointly process the latent representation and the at least some of the one or more prompts to generate transformed prompts and transformed features.

4. The audio coding system of claim 3, wherein the conditional feature extractor further comprises a conditioning module configured to perform feature-wise modulation of the transformed features using the transformed prompts.

5. The audio coding system of claim 1, wherein the permutation-invariant training aligns separated outputs with reference signals for multiple prompts from the one or more prompts of the same category.

6. The audio coding system of claim 1, wherein the quantizer comprises a residual vector quantization module configured to discretize the separated latent features into discrete code sequences.

7. The audio coding system of claim 1, wherein the decoder comprises a plurality of layers including: convolutional layers and transformer layers, wherein the plurality of layers is configured to reconstruct the one or more output audio signals from the discrete code sequences.

8. The audio coding system of claim 1, wherein the audio coding system is configured to operate in a plurality of modes, comprising:
a first mode in which a single source prompt produces a single code sequence;
a second mode in which multiple prompts produce multiple code sequences corresponding to different sources; and
a third mode in which a mixture prompt produces a code sequence representing a combination of sources.

9. The audio coding system of claim 1, wherein the audio coding system is configured to process, at inference, combinations of prompts not encountered during training.

10. The audio coding system of claim 1, wherein the input encoder is configured to generate a time-frequency representation of the input audio signal, and the conditional feature extractor is configured to disentangle the time-frequency representation into source-specific features.

11. The audio coding system of claim 1, wherein each of the quantizer and the decoder are shared across the one or more prompts, thereby avoiding the use of separate domain-specific quantizers.

12. The audio coding system of claim 1, wherein the audio coding system is further configured to provide, as output, the discrete code sequences usable by a downstream machine learning model for a downstream task, the downstream task comprising at least one of: transcription, captioning, or audio classification.

13. The audio coding system of claim 1, wherein the conditional feature extractor is trained to reconstruct both the separated sources and the mixtures of sources, based on receiving either of: a source-specific prompt or a mixture prompt, as the at least some of the one or more prompts.

14. The audio coding system of claim 1, wherein the audio coding system is configured to reconstruct an arbitrary number of sources, without a predefined limit, based on a corresponding number of prompts provided as input.

15. The audio coding system of claim 1, wherein the one or more prompts comprise learnable vectors that are jointly optimized with each of the input encoder, the quantizer, and the decoder during training.

16. The audio coding system of claim 1, wherein the conditional feature extractor is further configured to disentangle multiple sources of a same type based on permutation-invariant training, and wherein the quantizer and the decoder are shared across the one or more sound sources.

17. The audio coding system of claim 1, wherein the one or more prompts comprise at least:
one or more target prompts indicative of the one or more of the one or more sound sources, and
one or more context prompts indicative of at least a context for encoding of the one or more of the one or more sound sources among the one or more sound sources.

18. A method for audio coding, wherein the method uses a processor coupled with stored instructions implementing the method, wherein the instructions, when executed by the processor carry out steps of the method, comprising:
receiving an input audio signal comprising a mixture of two or more sound sources;
generating a latent representation of the received input audio signal;
receiving one or more prompts indicative of one or more of the one or more of the sound sources in the mixture;
generating, based on the latent representation and the received one or more prompts, one or more separated latent features corresponding to the one or more of the one or more sound sources corresponding to at least some of the one or more prompts;
generating, via a quantizer, discretized latent features based on the one or more separated latent features;
generating one or more sequences of codes based on the discretized latent features; and
reconstructing, via a decoder, one or more audio signals from the one or more sequences of codes, the one or more audio signals corresponding to the one or more of the one or more sound sources indicated by the at least some of the one or more prompts.

19. The method of claim 18, further comprising:
jointly processing, via a conditional feature extractor including a cross-prompt module, the latent representation and the at least some of the one or more prompts to generate transformed prompts and transformed features.

20. The method of claim 19, further comprising:
executing, via the conditional feature extractor, a feature-wise modulation operation on the transformed features using the transformed prompts.
